(19) United States
(12) Patent Application Publication
(10) Pub. No.: US 2005/0212943 A1
(43) Pub. Date: Sep. 29, 2005

(54) Digital camera

(75) Inventors: Toshihiko Karasaki, Kawachinagano-shi (JP); Hitoshi Hagimori, Ikoma-gun (JP); Yong Xin Huang, Kobe-shi (JP); Masahito Niikawa, Sakai-shi (JP)

Correspondence Address: SIDLEY AUSTIN BROWN & WOOD LLP, 717 NORTH HARWOOD, SUITE 3400, DALLAS, TX, 75201, US

(73) Assignee: KONICA MINOLTA PHOTO IMAGING, INC.

(21) Appl. No.: 11/007,926

(22) Filed: Dec. 9, 2004

(30) Foreign Application Priority Data
Mar. 29, 2004 (JP) JP2004-095536

(51) Int. Cl. H04N 5/222; H04N 5/225; H04N 5/76; G03B 17/24

(52) U.S. Cl. 348/333.02; 348/207.2; 348/231.6; 396/311

(57) ABSTRACT

The digital camera has an LCD and a print button and can set image capturing modes such as a single frame shooting mode and a continuous shooting mode. In the case where the print button is depressed in a state where the digital camera is set in the single frame shooting mode, after making an error check, the digital camera immediately shifts to a state where a print mode is set. In the print mode, a print setting screen in which settings of a print order can be made on an image recorded on a memory card is displayed on the LCD. As a result, settings of the print order can be made promptly.

This application is based on application No. 2004-095536 filed in Japan, the contents of which are hereby incorporated by reference.

### BACKGROUND OF THE INVENTION

1. Field of the Invention

The present invention relates to a digital camera having image capturing means which acquires an image by taking a picture of a subject via a taking lens.

2. Description of the Background Art

In a digital camera, generally, a very complicated operation is necessary to make settings of a print order.

For example, there is a digital camera capable of making print settings on a captured still image being displayed on a display only by an operation of depressing a dedicated print button (concretely, a DPOF(R) dedicated switch).

In the digital camera, print settings can be made in a state where a still image is being displayed in a playback mode, simplified reproduction is being performed in an image capturing mode, a still image is being displayed immediately after image capture, or a still image is being displayed by automatic frame advance.

In the digital camera, however, print settings can be made only under specific conditions requiring a shift to the playback mode or simplified reproduction in the image capturing mode. Consequently, since in reality it is difficult to make print settings only by a single operation to a print button, the user has to perform many operations, and it is difficult to make prompt print settings.

### SUMMARY OF THE INVENTION

The present invention is directed to a digital camera.

According to the present invention, the digital camera having an image capturing part which captures an image of a subject formed by an optical member comprises: (a) a display part which displays an image captured by the image capturing part; (b) a mode setting member which sets an image capturing mode for capturing an image of the subject by the image capturing part; and (c) a display controller which displays a print setting screen regarding printing of an image on the display part when a predetermined operation member is operated during a predetermined image capturing operation or recording of an image in the image capturing mode set by the mode setting member. Therefore, settings of a print order can be made promptly.

In a preferred embodiment of the present invention, in the digital camera, when the predetermined operation member is operated during a live view display in the image capturing mode, the display controller displays the print setting screen on the display part. Therefore, settings of a print order can be made promptly even in a state where a live view is displayed.

It is therefore an object of the present invention to provide a digital camera capable of promptly making settings of a print order.

These and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a diagram showing the outside configuration of a digital camera according to a preferred embodiment of the present invention;

FIG. 2 is a diagram showing the outside configuration of the digital camera;

FIG. 3 is a diagram showing the inside configuration of the digital camera;

FIG. 4 is a diagram showing a data sequence in a memory card;

FIGS. 5 and 6 are diagrams respectively illustrating a print order file;

FIGS. 7 and 8 are diagrams respectively illustrating a print setting screen;

FIGS. 9 to 12 are diagrams respectively showing operations in a print mode;

FIG. 13 is a diagram illustrating an enlarged print preview screen;

FIG. 14 is a flowchart showing operations of print order recording;

FIG. 15 is a diagram illustrating a print menu screen;

FIG. 16 is a diagram showing items displayed on the print menu screen;

FIGS. 17A to 17D are diagrams respectively illustrating displays regarding the total number of prints;

FIG. 18 is a diagram showing operations of print initial setting;

FIGS. 19 and 20 are diagrams respectively showing operations of print total number display setting;

FIG. 21 is a state transition diagram showing basic operations of the digital camera;

FIG. 22 is a diagram showing the relation between the print mode and other four kinds of modes;

FIG. 23 is a flowchart showing error check operation;

FIG. 24 is a diagram showing processes performed in the case where the print button is depressed in the states of the digital camera in the playback mode;

FIGS. 25 and 26 are diagrams respectively showing the operations of the digital camera in the playback mode;

FIG. 27 is a diagram showing processes performed in the case where the print button is depressed in the states of the digital camera in the image capturing mode;

FIG. 28 is a diagram showing operations of the digital camera in a single frame shooting mode;

FIG. 29 is a diagram showing operations of the digital camera in a continuous shooting mode;

FIG. 30 is a diagram showing operations of the digital camera in a motion picture mode; and

FIGS. 31 and 32 are diagrams respectively showing operations of the digital camera regarding an image capturing menu.

### DESCRIPTION OF THE PREFERRED EMBODIMENTS

Hereinafter, preferred embodiments of the present invention will be described with reference to the drawings.

Outline of Configuration

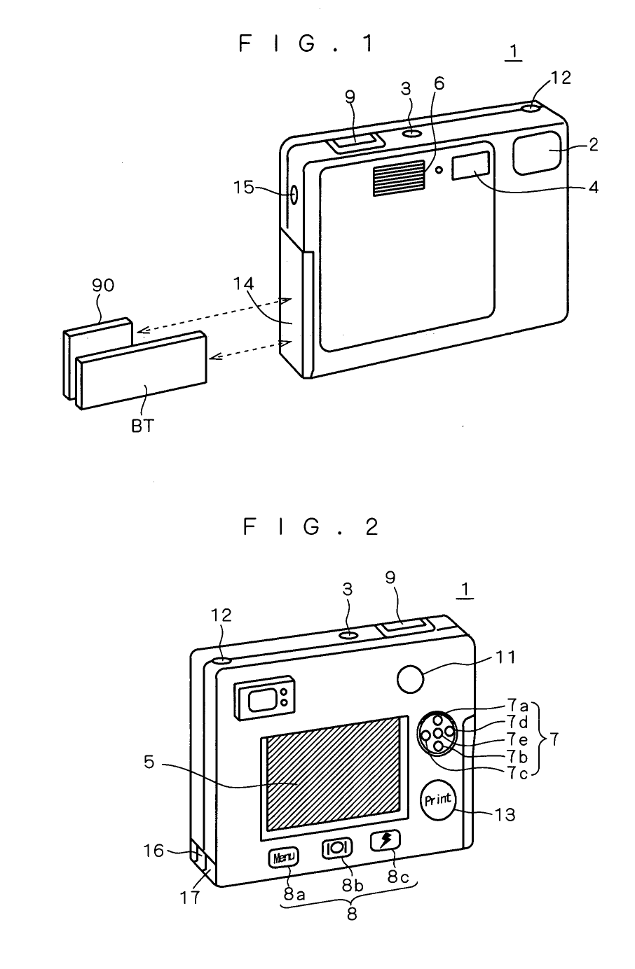

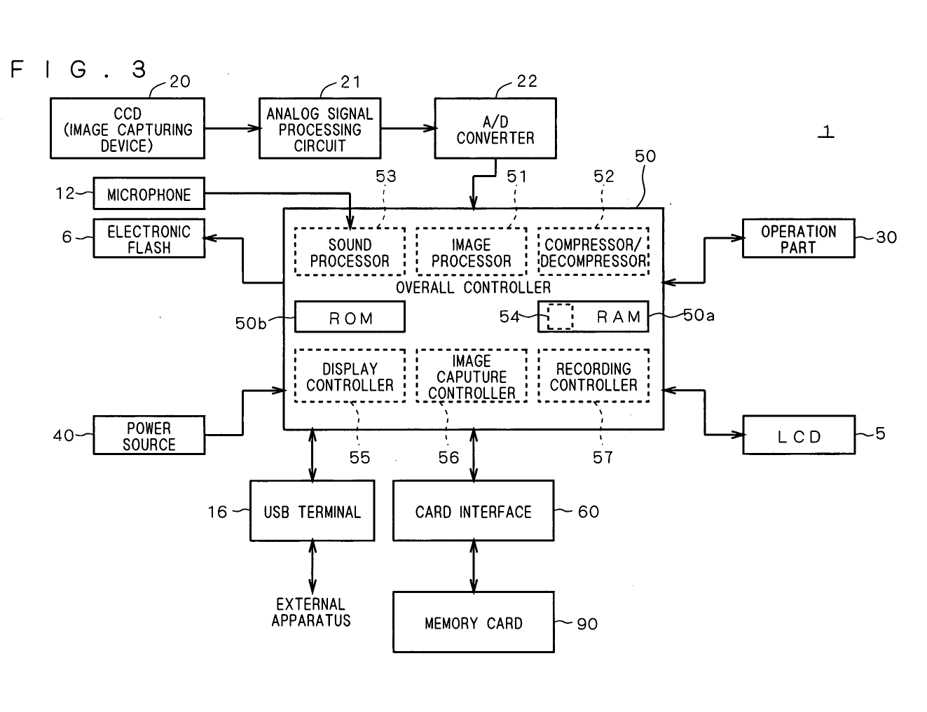

FIGS. 1 and 2 are diagrams showing the outside configuration of a digital camera 1 according to a preferred embodiment of the present invention. FIG. 1 is a schematic perspective view from the front side and FIG. 2 is a schematic perspective view from the rear side.

As shown in FIGS. 1 and 2, the digital camera 1 is thin and has an almost rectangular parallelepiped shape.

As shown in FIG. 1, the digital camera 1 has, on its front face side, a taking lens 2, an optical viewfinder 4 and an electronic flash 6, and has, on its top face side, a power source button 3, a shutter button (release button) 9 and a microphone 12. As shown in FIG. 2, the digital camera 1 has, on its rear face side, a liquid crystal display (hereinafter, referred to as LCD) 5, button groups 7 and 8, a mode switching button 11 and a print button 13. The button group 7 is constructed by cross cursor buttons 7a to 7e (hereinafter, also referred to as up button 7a, down button 7b, left button 7c, right button 7d and center (execution) button 7e). The button group 8 has a menu button 8a, a liquid crystal monitor button 8b and an electronic flash mode button 8c. Further, as shown in FIGS. 1 and 2, the digital camera 1 also has, on its side faces, a cover 14, a DC input terminal 15, a USB terminal 16 and an AV output terminal 17.

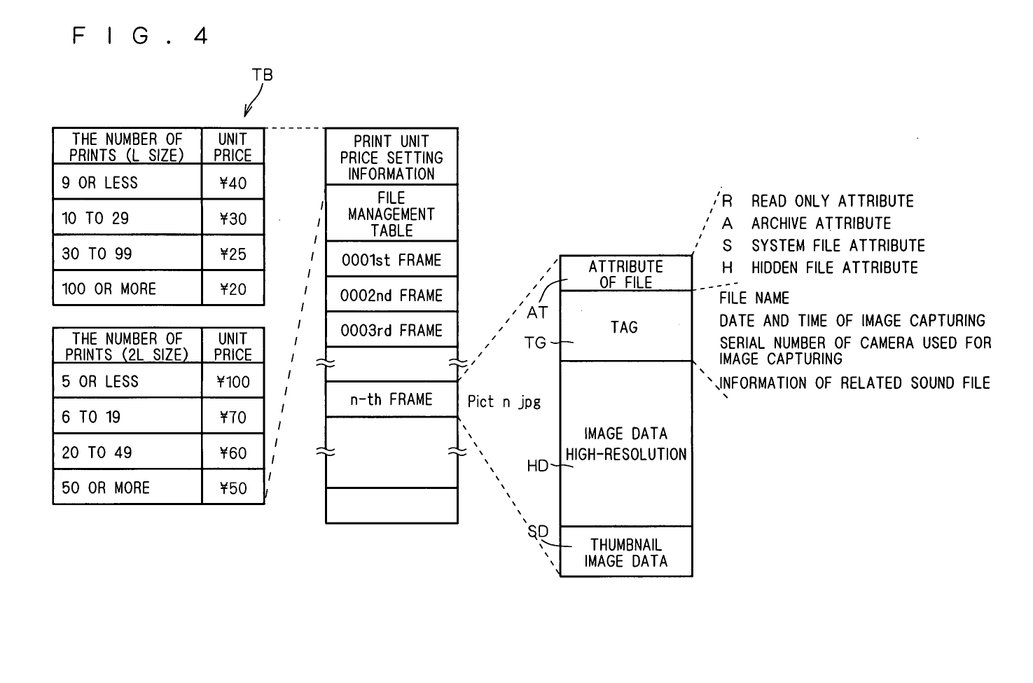

As will be described later, the digital camera 1 obtains image data of a subject by photoelectrically converting an image of the subject from the taking lens 2 by a CCD (Charge Coupled Device) 20 (FIG. 3).

The power source button 3 is used for accepting an operation of turning on/off the power source. Concretely, each time the power source button 3 is depressed, the power source is switched between the ON and OFF states.

The shutter button 9 is a two-level press switch capable of detecting a half-pressed state (hereinafter, also referred to as an S1 state) and a depressed state (hereinafter, also referred to as an S2 state) set by the user (operator). In the half-pressed (S1) state, automatic focus control is started. In the depressed (S2) state, image capturing operation for capturing an image to be recorded is started.

The LCD 5 performs preview display (also referred to as live view display) before the image capturing operation and playback and display of a recorded image. The LCD 5 has a predetermined number of display pixels (in this case, 320×240) and can display a color image. The LCD 5 functions as a display part capable of displaying an image captured in an image capturing mode (which will be described later) and recorded.

After the power source of the digital camera 1 is turned on or the image capturing operation is completed, in the live view display, capturing of an image of the subject is repeated at low resolution every 1/30 second and the captured image is displayed in a motion picture mode on the LCD 5. By the live view display on the LCD 5, the user can perceive the position, size and the like of the subject in the captured image and perform framing operation. The framing operation can be also performed by using only the optical viewfinder 4 without using the LCD 5.

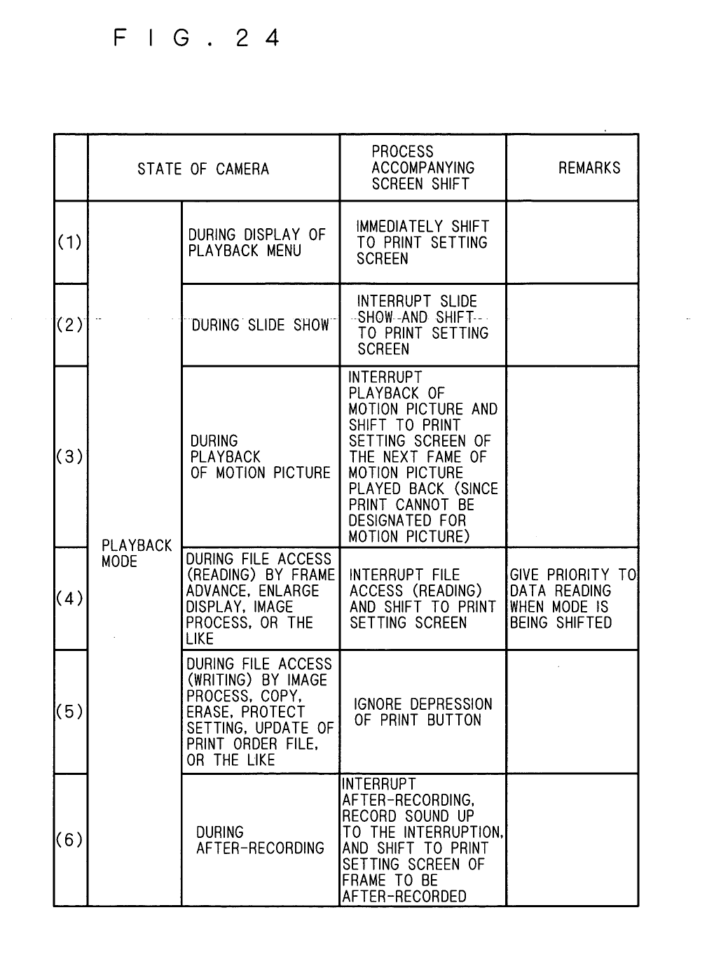

By depressing the mode switching button 11, the mode is cyclically switched among the single frame shooting-mode, continuous shooting mode, motion picture mode and playback mode (see FIG. 22). The single frame shooting mode, continuous shooting mode and motion picture mode are included in the image capturing mode. The image capturing mode is a mode of performing photographing, and the playback mode is a mode of playing back a captured image recorded on a memory card and displaying the image played back on the LCD 5. The digital camera 1 of the preferred embodiment is set in the image capturing mode at the turn-on of the power source by depression of the power source button 3. By depressing the mode switching button 11, the mode can be switched to the playback mode. By further depressing the mode switching button 11, the mode is switched to the single frame shooting mode in the image capturing mode.

The menu button 8a has a function of switching between display and non-display of a menu on the LCD 5. For example, each time the menu button 8a is depressed in the initial screen of any operation mode, a menu screen and a screen without a menu (display screen of a live view, an image played back or the like) are alternately displayed on the LCD 5. A display cursor in the menu screen displayed on the LCD 5 can be moved in four ways by using the cross cursor buttons 7a to 7d. Further, by depressing the execution (center) button 7e in the state where a desired option is selected, a setting operation or the like corresponding to the option can be executed. By such operation, various image capturing parameters can be set.

The liquid crystal monitor button 8b is a button for switching the state between display and non-display of an image on the LCD 5 as a liquid crystal monitor. Each time the liquid crystal monitor button 8b is depressed, a state where an image or the like is displayed (display state) and a state where no image is displayed (non-display state) are alternately switched. In the non-display state, power consumption can be decreased.

The electronic flash mode button 8c is a button for determining the mode of the electronic flash 6. Each time the electronic flash mode button 8c is depressed, the electronic flash mode is switched to an automatic electronic flash mode, a forced electronic flash mode and an electronic flash inhibited mode in this order.

The microphone 12 is used for obtaining (recording) sound data at the time of motion picture capturing, voice memo, voice recording and after-recording.

The print button 13 is a button for shifting the mode to a print mode (which will be described later).

The cover 14 is provided in a portion to cover a battery chamber and a memory card insertion part. In other words, on the inside of the cover 14, a battery chamber for housing a power source battery BT and a memory card insertion part in which a memory card 90 as a detachable recording medium (portable recording medium) is inserted are provided. The power source battery BT and the memory card 90 are detachably inserted in the battery chamber and the memory card insertion part, respectively. Image data and the like obtained by the image capturing operation is recorded on the memory card 90 which is inserted into the insertion part. The digital camera 1 can receive power supply from the power source battery BT and power supply from an AC adapter (not shown) or the like by using the DC input terminal 15.

The USB terminal 16 is a terminal for performing data communication with a personal computer. By connecting a USB standard cable or the like to the USB terminal 16, data communication can be performed with an external apparatus (personal computer or the like).

The AV output terminal 17 is a terminal for connecting the digital camera 1 to an external audio visual apparatus (AV apparatus) such as a television. By connecting the AV output terminal 17 and an input terminal of the external AV apparatus via a predetermined AV code, an image and/or sound can be outputted to the external AV apparatus.

The inside configuration of the digital camera 1 will now be described with reference to FIG. 3. FIG. 3 is a block diagram showing the internal functions of the digital camera 1.

The CCD (image capturing device) 20 functions as image capturing means for capturing an image of a subject and generating an electronic image signal and has, for example, 1600×1200 pixels. The CCD 20 photoelectrically converts a light image of the subject formed by the taking lens 2 into an image signal of color components of R (red), G (green) and B (blue) on a pixel unit basis (signal constructed by a signal sequence of pixel signals received by the pixels) and outputs the image signal.

The image signal obtained from the CCD 20 is supplied to an analog signal processing circuit 21 where the image signal (analog signal) is subjected to predetermined analog signal processes. The analog signal processing circuit 21 has a correlated double sampling (CDS) circuit and an auto gain control (AGC) circuit. A process of reducing noise in the image signal is performed by the CDS circuit and the gain is adjusted by the AGC circuit, thereby performing level adjustment of the image signal.

An A/D converter 22 converts each of pixel signals of the image signal into a digital signal of 12 bits. The digital signal obtained by the conversion is temporarily stored as image data into a buffer memory 54 in an RAM 50a. On the image data stored in the buffer memory 54, WB (White Balance) process, γ correcting process, color correcting process and the like are performed by an image processor 51 which will be described later, and the processed data is subjected to compressing process or the like in a compressor/decompressor 52.

A sound signal obtained from the microphone 12 is inputted to a sound processor 53. The sound signal inputted to the sound processor 53 is converted by an A/D converter (not shown) provided in the sound processor 53 into a digital signal, and the digital signal is temporarily stored in the buffer memory 54.

An operation part 30 is an operation part including the power source button 3, button groups 7 and 8, shutter button 9 and mode switching button 11 and is used by the user to perform an operation of changing the setting state of the digital camera 1, an image capturing operation, and the like.

A power source 40 is a power supply source for the digital camera 1. The digital camera 1 is driven by using a secondary battery such as a lithium ion battery as the power source battery BT.

An overall controller 50 is constructed by a microcomputer having therein the RAM 50a and a ROM 50b and controls the above-described components in a centralized manner when the microcomputer executes a predetermined program. The RAM 50a is a semiconductor memory which can be accessed at high speed (for example, DRAM). The ROM 50b is an electrically rewritable nonvolatile semiconductor memory (for example, a flash ROM). A region in a part of the RAM 50a functions as a buffer area for temporary storage. Herein, the buffer area is also referred to as the buffer memory 54. The buffer memory 54 temporarily stores image data and sound data.

The overall controller 50 has the image processor 51, compressor/decompressor 52 and sound processor 53. The overall controller 50 also has a display controller 55 for performing a display control regarding the print setting screen, an image capture controller 56 for generating an AF evaluation value (control data regarding image capturing), and a recording controller 57 for performing a recording control on the memory card 90. The processors 51 to 53 and the controllers 55 to 57 are a function part realized when the microcomputer executes a predetermined program.

The image processor 51 is a processor for performing various digital image processes such as WB process and y correcting process. The WB process is a process for performing level conversion of each of the color components of R, G and B and adjusting color balance. The y correcting process is a process for correcting the tone of pixel data. The compressor/decompressor 52 is a processor for performing a process of compressing/decompressing image data. As a compressing method, for example, the JPEG system is employed. The sound processor 53 is a processor for performing various digital processes on sound data.

By the overall controller 50 having such a configuration, processes are performed in the image capturing mode, playback mode and print mode. For example, when the shutter button 9 is half-pressed (S1 state) by the user in the image capturing mode, an AF evaluation value is obtained on the basis of image data outputted from the CCD 20 in a state where a live view is displayed and is stored in the RAM 50a, and the taking lens is moved to a focus position by a known hill-climbing method. On the basis of luminance information of the subject read by the CCD 20, shutter speed, an f-number value, and a gain set value of auto white balance at the time of image capturing are determined.

On the other hand, when the shutter button is depressed (S2 state) in the image capturing mode, the overall controller 50 sets the resolution of the CCD 20 to high resolution, captures an image of a subject, and generates a compressed image by the compressor/decompressor 52 on the basis of image data captured by the CCD 20. The compressed high-resolution image data is recorded on the memory card 90 functioning as a recording medium. The data structure in the memory card 90 will be described below.

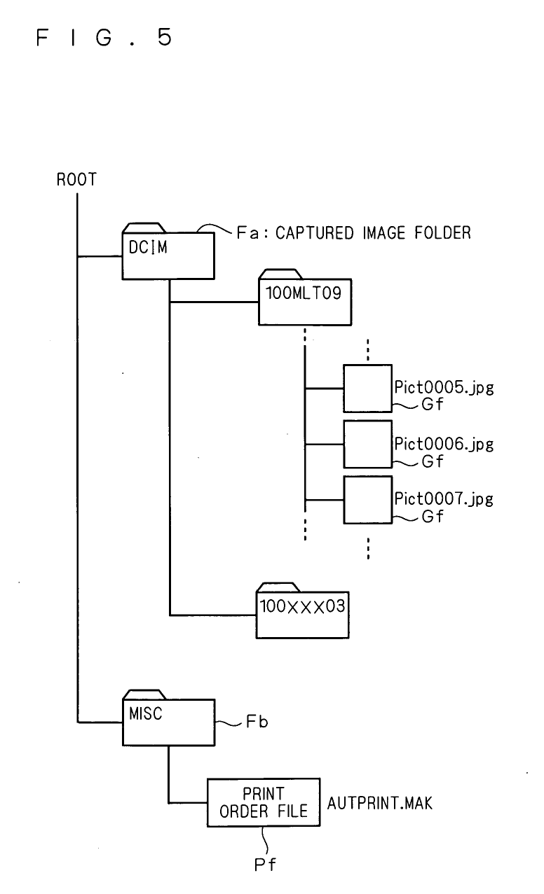

FIG. 4 is a diagram showing a data sequence of the memory card 90. In the memory card 90, frames of a still picture and a motion picture recorded by the digital camera 1 are stored sequentially. In each frame, a file attribute AT, tag information TG, high-resolution image data HD (1600×1200 pixels) compressed in the JPEG format, and thumbnail image data SD (320×240 pixels) for displaying a thumbnail image are recorded. In the file attribute AT, read only attribute (R), archive attribute (A), system file attribute (S) and hidden file attribute (H) can be set. In the case where protection of a file is set by the user, the read only attribute is set. In the tag TG, information of file name, date and time of image capturing, serial number of a digital camera used for the image capturing, and sound file associated with image data is recorded.

In the memory card 90, encrypted print unit price information is stored as a table TB in which the relation between the number of prints and unit price is described. With reference to the print unit price table TB, for example, when the print size is L and the number of prints is 9 or less, the print unit price is set as 40 yen. For example, when the print size is 2L and the number of prints is 50 or more, the print unit price is set as 50 yen. In such a manner, print charge which will be described later is displayed on the LCD 5.

When the image capturing mode is switched to the playback mode by depression of the mode switching button 11, data of an image of the largest frame number in the memory card 90, that is, an image captured most recently is read and decompressed by the compressor/decompressor 52, and the resultant image is displayed on the LCD 5. In the playback mode, the frame advance and frame reverse can be performed by depression of the left button 7c and the right button 7d, respectively.

A card interface (I/F) 60 is an interface for writing/reading image data to/from the memory card 90 inserted in the insertion part in the side face of the digital camera 1.

At the time of reading/writing image data from/to the memory card 90, the process of compressing/decompressing image data is performed in, for example, the JPEG system by the compressor/decompressor 52 and image data is transmitted/received between the buffer memory 54 and the memory card 90 via the card interface 60. Also at the time of reading/writing sound data, sound data is transmitted/received between the buffer memory 54 and the memory card 90 via the card interface 60.

Further, by using the card interface 60, the digital camera 1 can perform not only transmission/reception of data such as an image and sound but also reception of a program which operates on the digital camera 1. For example, a control program recorded on the memory card 90 can be stored into the RAM 50a or ROM 50b in the overall controller 50. Consequently, the control program can be updated.

Also by communication with an external apparatus (such as an external computer) via the USB terminal 16, various data such as an image and sound, a control program or the like can be transmitted/received. For example, various data, a program or the like recorded on a recording medium (such as CD-R/RW or CD-ROM) set in a reading device (such as an optical drive device) of an external computer can be obtained via the USB terminal 16.

Print Mode

When the print button 13 is depressed by the user, the digital camera 1 enters the print mode for performing print settings, and a print setting screen is displayed.

In the print mode, a print order file regarding print settings is created. The print order file will be described first.

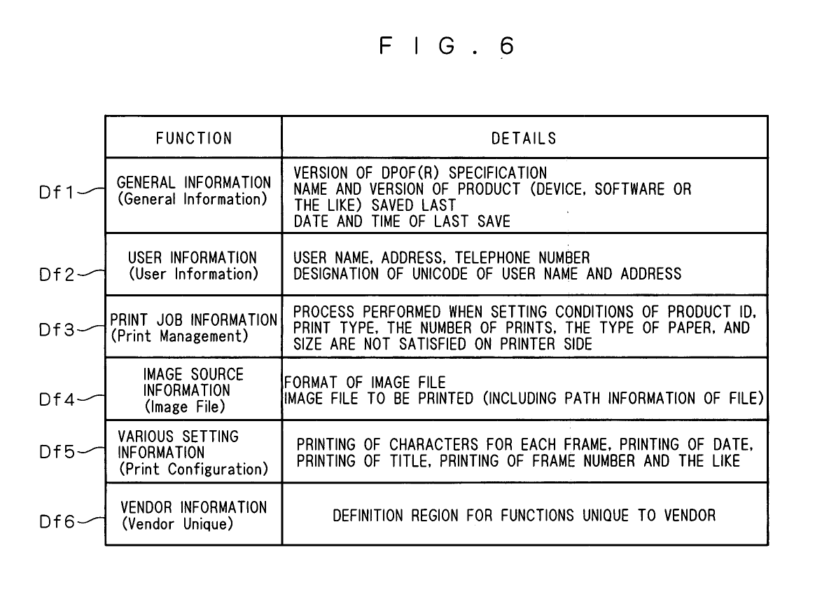

FIG. 5 is a diagram for describing a print order file Pf.

In the memory card 90, a plurality of image files Gf are stored in a captured image folder Fa and the print order file Pf is stored in a folder Fb different from the captured image folder Fa.

The print order file Pf is constructed by, as shown in FIG. 6, general information Df1, user information Df2, print job information Df3, image source information Df4, various settings information Df5 and vendor information Df6. The vendor information Df6 is information which is defined by each of manufactures of digital cameras.

By creating the print order file Pf, labor of the user at the time of print order can be reduced. The print setting screen for setting the various information Df1 to Df6 in the print order file Pf will now be described.

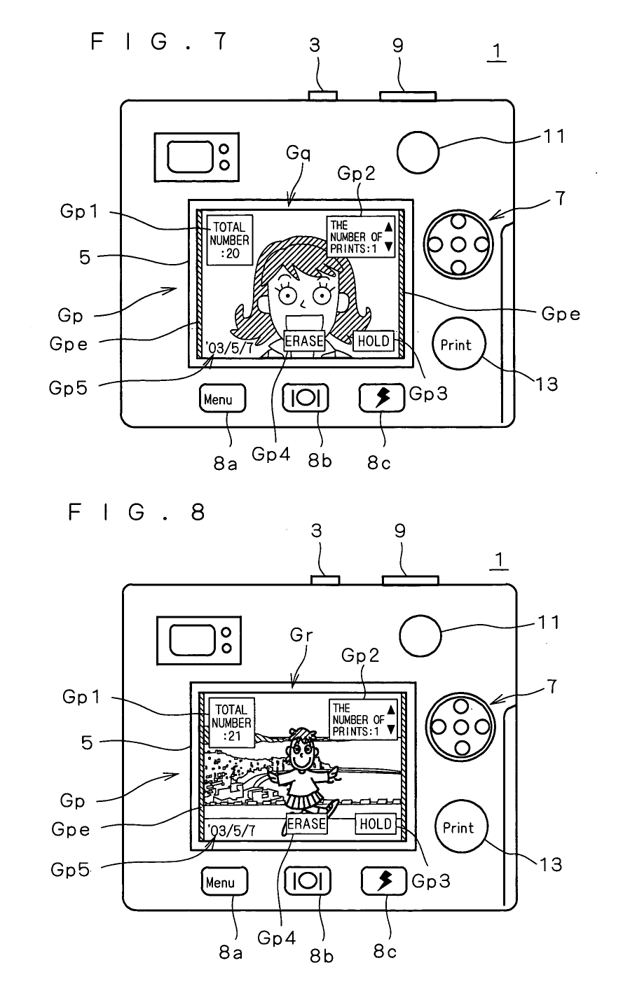

FIG. 7 is a diagram for describing the print setting screen.

In a print setting screen Gp displayed on the LCD 5, total number display Gp1 for displaying the total number of images ordered to be printed and order number display Gp2 of the number of prints ordered of an image presently displayed on the LCD 5, the display Gp2 being in an upper right portion of the screen on the LCD 5, are performed so as to superimpose on an image Gq to be printed. In short, a captured image as a target of print settings and the presence or absence of print settings on the captured image are displayed on the LCD 5.

On the other hand, when the digital camera 1 shifted to the print mode in response to depression of the print button 13, the electronic flash mode button 8c functions as a hold button, and the liquid crystal monitor button 8b functions as an erase button. In the print setting screen Gp, “hold” display Gp3 and “erase” display Gp4 for indicating that the functions are assigned are performed.

In the digital camera 1, in order to give priority to a print image, the image Gq is displayed in accordance with the aspect ratio of the print size. When the aspect ratio of the screen size of the LCD 5 and that of the print size are different from each other, for example, the size is adjusted by providing margins Gpe (parallel hatched parts) in both ends of the screen of the LCD 5. In the case of superimpose the date of image capturing on the image Gq, date display Gp5 such as “'03/5/7” is made in a superimpose portion of the image.

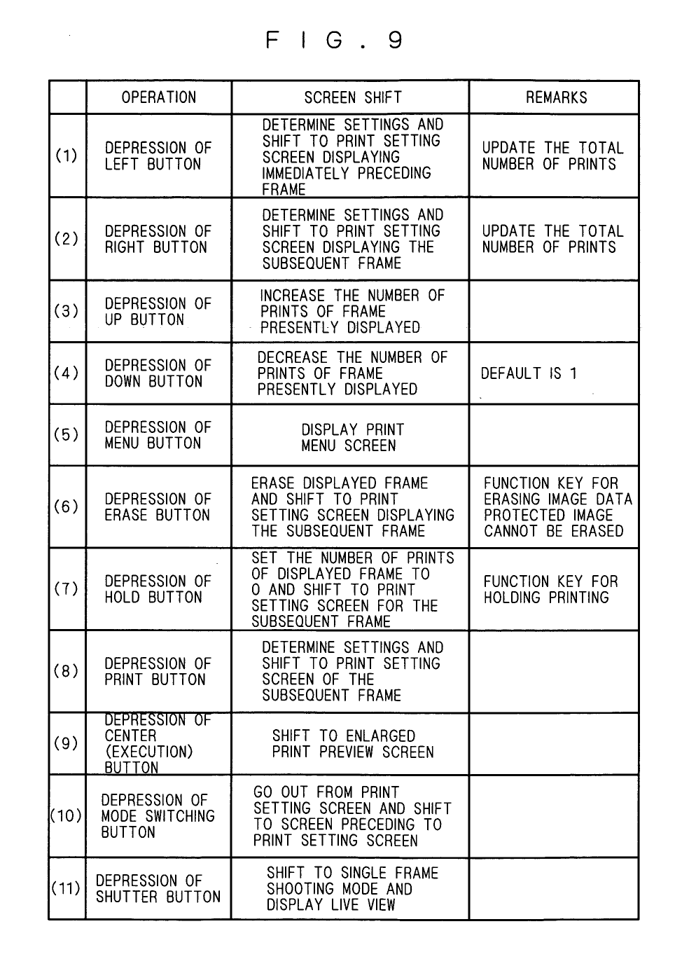

In the print setting screen Gp shown in FIG. 7, when the right button 7d or print button 13 is depressed, the subsequent image (frame) Gr is displayed as shown in FIG. 8 (to be described in detail later).

The operations in the print mode will now be described.

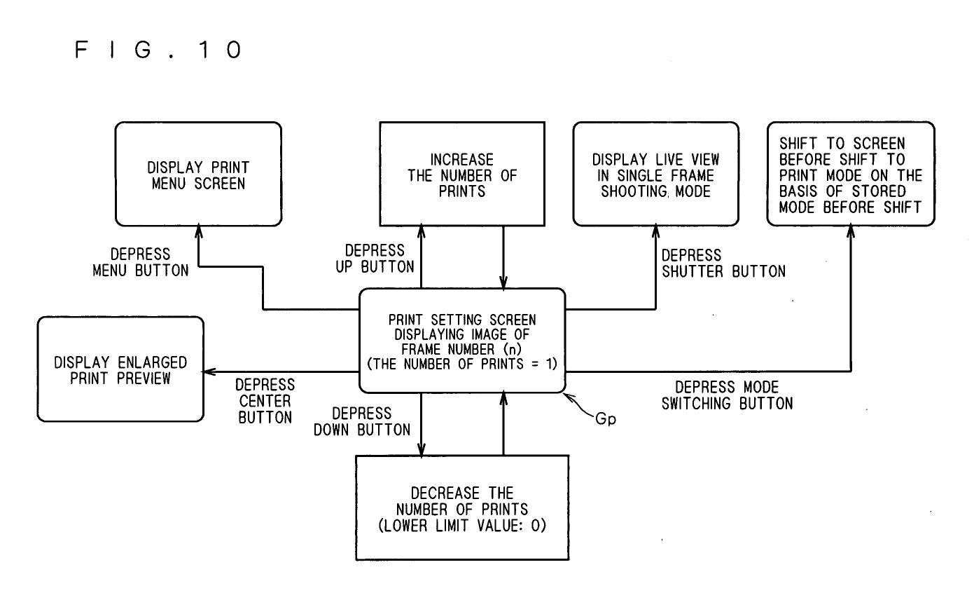

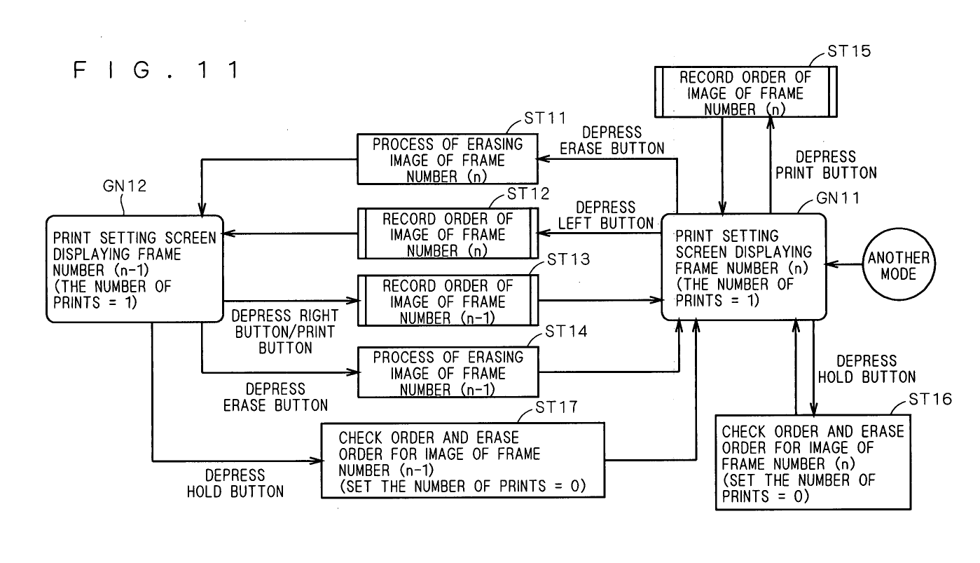

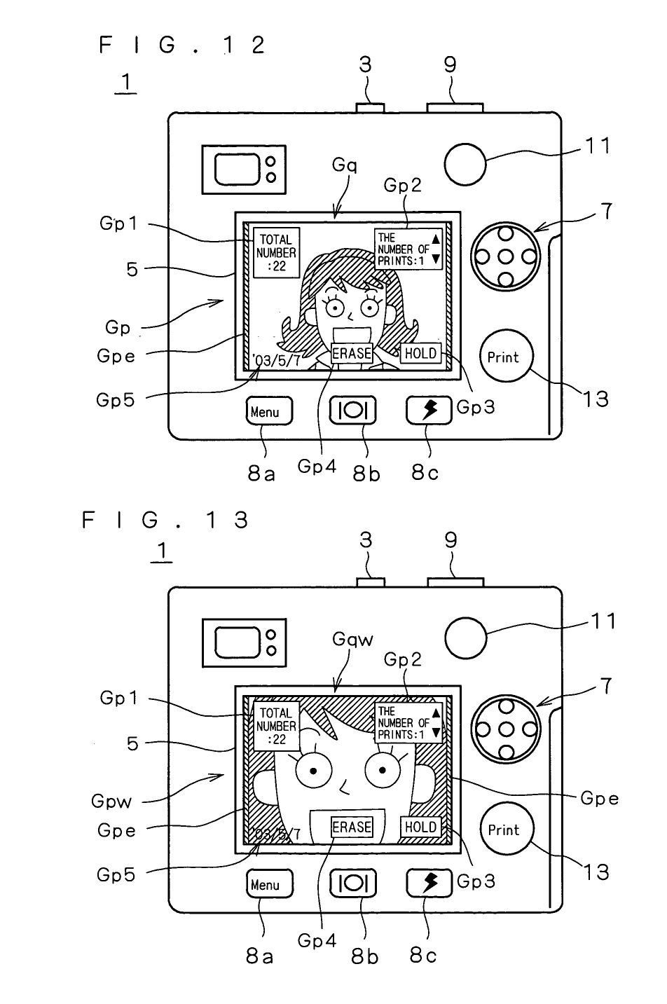

FIGS. 9 to 11 are diagrams for describing operations in the print mode for displaying the print setting screen Gp (FIG. 7) on the LCD 5. FIG. 9 shows the relation between the operation of the user and the screen transition and each of FIGS. 10 and 11 shows a state of transition from a print setting screen GN11 displaying an image of the frame number (n) to another screen. In the following description, the image of the frame number (n) will be regarded as an image having the latest (largest) frame number immediately after shift to the print mode. In FIG. 11, blocks having reference symbols starting with GN indicate states of the display screen, and blocks having reference symbols starting with ST show operations of the digital camera 1.

In the following, the operations of the print mode will be described with reference to FIGS. 10 and 11 for each of items (1) to (11) shown in FIG. 9.

(1) When the left button 7c is depressed, the settings made in the print setting screen are determined and the program shifts to the print setting screen displaying the immediately preceding frame. In this case, the print order number selected in the image before depression of the left button 7c is added to the print total number, and the total number is updated.

Specifically, in the case where the left button 7c is depressed in the print setting screen GN 11 displaying an image of the frame number (n) shown in FIG. 11, a process ST12 (which will be described in detail later) of recording the print order of the image of the frame number (n) is performed, and the program shifts to a print setting screen GN12 of the image of the frame number (n-1).

Concretely, for example, when the left button 7c is depressed in the state where the print setting screen Gp is displayed as shown in FIG. 8, as shown in FIG. 12, the image Gq corresponding to the immediately preceding frame is displayed on the LCD 5 and, in the total number display Gp 1, the total number “22” obtained by increasing “21” in the total number display Gp1 of FIG. 8 by one is displayed.

(2) When the right button 7d is depressed, settings in the print setting screen are determined and the program shifts to the print setting screen displaying the subsequent frame. In this case, the print order number selected in the image before depression of the right button 7d is added to the print total number, and the total number is updated.

Specifically, when the right button 7d is depressed in the print setting screen GN12 displaying the image of the frame number (n-1) shown in FIG. 11, a process ST13 (which will be described in detail later) of recording the print order of the image of the frame number (n-1) is performed, and the program shifts to he print setting screen GN11 of the image of the frame number (n).

Concretely, for example, when the right button 7d is depressed in the state where the print setting screen Gp is displayed as shown in FIG. 7, as shown in FIG. 8, an image Gr corresponding to the subsequent frame is displayed on the LCD 5, and the total number “21” obtained by increasing “20” shown in the total number display Gp1 of FIG. 7 by one is displayed in the total number display Gp1.

(3) When the up button 7a is depressed, as shown in FIG. 10, the number of prints of the frame (image) which is currently displayed on the LCD 5 is increased. Therefore, the number in the print number display Gp2 increases.

(4) When the down button 7b is depressed, as shown in FIG. 10, the number of prints of the frame (image) which is currently displayed on the LCD 5 is decreased. Therefore, the number in the print number display Gp2 decreases. The default value of the number of prints is set as 1 and the lower limit value of the print number is 0.

(5) When the menu button 8a is depressed, as shown in FIG. 10, the print menu screen (which will be described later) is displayed on the LCD 5.

(6) When the erase button 8b is depressed, the frame (image) which is currently displayed on the LCD 5 is erased, and the program shifts to the print setting screen displaying the subsequent frame. The erase button 8b functions as a function key for erasing captured image data. It is assumed that even when the erase button 8b is depressed, a protected image, concretely, an image which is set in the read only attribute in the file attribute shown in FIG. 4 cannot be erased. By an operation input on the erase button 8b, data of the captured image can be erased also in the playback mode. Therefore, since the button having the erasing function is commonly used in the playback mode and the print mode, an operation error regarding erasure of captured image data can be reduced.

For example, when the erase button 8b is depressed in the print setting screen GN 12 displaying the image of the frame number (n-1) shown in FIG. 11, a process ST 14 of erasing the image of the frame number (n-1) is performed, and the program shifts to the print setting screen GN11 displaying the image of the frame number (n).

When the erase button 8b is depressed in the print setting screen GN11 displaying the image of the maximum frame number (n) shown in FIG. 11, a process ST11 for erasing the image of the frame number (n) is performed and, after that, the program shifts to the print setting screen GN12 displaying an image of the maximum frame number (n-1) after the erasing process.

(7) When the hold button 8c is depressed, the number of prints of the frame (image) currently displayed on the LCD 5 is set to 0, and the program shifts to the print setting screen displaying the subsequent frame. In response to an operation input on the hold button 8c, the program shifts to the print setting screen of an image of the subsequent frame number of the image being displayed on the LCD 5. The shift is not limited to the image of the subsequent frame number of the image being displayed, but the program may be shifted to the print setting screen of an image of the preceding frame number.

Specifically, when the hold button 8c is depressed in the print screen GN12 displaying the image of the frame number (n-1) shown in FIG. 11, the print order contents regarding the image of the frame number (n-1) are checked. When the print order number is 1 or more, a process ST17 for erasing the order contents regarding the image of the frame number (n-1), that is, for setting the number of prints to 0 is performed. The program shifts to the print setting screen GN11 displaying the image of the frame number (n). In the print setting screen GN11 of the frame number (n) immediately after the shift, the number of prints is temporarily set to the default value of 1, and “1” is displayed in the order number display Gp2 (see FIG. 7). In the case where the default value is set to 2 or more, the number of prints is set to 2 or more in the print setting screen immediately after the shift by depression of the hold button 8c.

In the case where the hold button 8c is depressed in the print setting screen GN11 displaying the image of the frame number (n) shown in FIG. 11, the order contents in the print order file regarding the image of the frame number (n) are checked. When the print order number is 1 or more, a step ST16 for erasing the order contents regarding the image of the frame number (n), that is, setting the number of prints to 0 is performed. Since the frame number (n) is the largest and the subsequent frame does not exist, the program returns to the print setting screen GN11 displaying the image of the frame number (n).

(8) When the print button 13 is depressed, the settings made in the print setting screen are determined, and the program shifts to the print setting screen displaying the next frame.

Specifically, when the print button 13 is depressed in the print setting screen GN12 displaying the image of the frame number (n-1) shown in FIG. 11, the ordering process ST13 (which will be described in detail later) of the image of the frame number (n-1) is performed, and the program shifts to the print setting screen GN11 displaying the image of the frame number (n).

Concretely, for example, when the print button 13 is depressed in the state where the print setting screen Gp of FIG. 7 is displayed, as shown in FIG. 8, the image Gr corresponding to the subsequent frame is displayed on the LCD 5 and the total number “21” obtained by increasing “20” in the total number display Gp1 of FIG. 7 by one is displayed in the total number display Gp1.

In the case where the print button 13 is depressed in the print setting screen GN11 displaying the image of the frame number (n) shown in FIG. 11, an ordering process ST15 (which will be described in detail later) on the image of the frame number (n) is executed. In this case, the frame number (n) is the largest and the next frame does not exist, so that the program returns to the print setting screen GN11 displaying the image of the frame number (n).

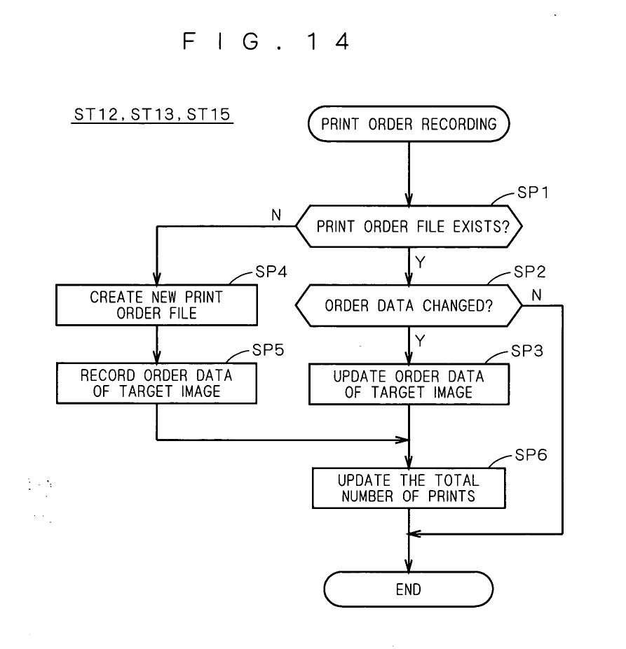

(9) When the center (execution) button 7e is depressed, the program shifts to an enlarged print preview screen Gpw (see FIG. 13) as shown in FIG. 10. In the enlarged print preview screen Gpw, an image Gqw of which display magnification is, for example, twice as large as the print setting screen Gp (see FIG. 7) in which the image Gq of which display magnification is once is displayed while the print setting information such as the total number display Gp1 and the order number display Gp2 remains the same without being enlarged. The user can visually recognize the details of the image of the enlarged print preview screen Gpw.

(10) When the mode switching button 11 is depressed, the program goes out from the print setting screen as shown in FIG. 10 and shifts to the screen (such as the menu screen of the image capturing mode) before the shift to the print setting screen on the basis of information of the shift source mode stored in the RAM 50a.

(11) When the shutter button 9 is depressed, as shown in FIG. 10, the program shifts to the single frame shooting mode and the live view display is made.

The order recording operation in steps ST12, ST13 and ST15 in FIG. 11 will be described below.

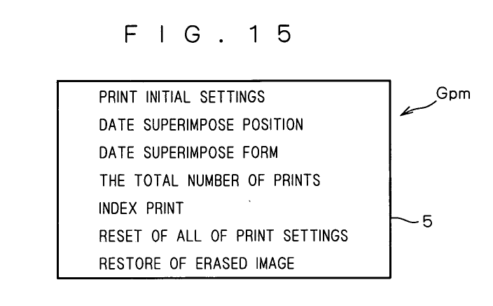

FIG. 14 is a flowchart showing the print order recording operation on an image of the frame number (n).

First, when the print button 13 or the like is depressed, it is determined whether the print order file exists in the memory card 90 or not (step SP1). In the case where a print order file exists, the program advances to step SP2. In the case where the print order file does not exist, the program advances to step SP4.

In step SP2, it is determined whether the order contents have been changed or not. For example, it is determined whether the number of prints has increased or not by depression of the up button 7a or down button 7b. If the order contents have been changed, the program advances to step SP3. If the order contents have not been changed, the program goes out from the flowchart and finishes the print order recording process.

In step SP3, the print order file is updated with the changed order contents of the image of the frame number (n) to be print ordered.

In step SP4, a print order file is newly created. Consequently, when the print button 13 is depressed and the program shifts to the print mode, a print order file is created in the memory card 90.

In step SP5, the order contents of the image of the frame number (n) to be print ordered are recorded in the print order file.

In step SP6, the total number of prints is updated. Consequently, the total number display Gp1 in the print setting screen is changed.

When the print settings are made on the captured image being displayed on the LCD 5 by the operation of the print order recording, the contents of the print settings are recorded on the memory card 90.

In the digital camera 1, by depressing the left button 7c or the right button 7d, at least one print of a desired image can be ordered. Thus, an order omission can be prevented and the convenience of the user improves.

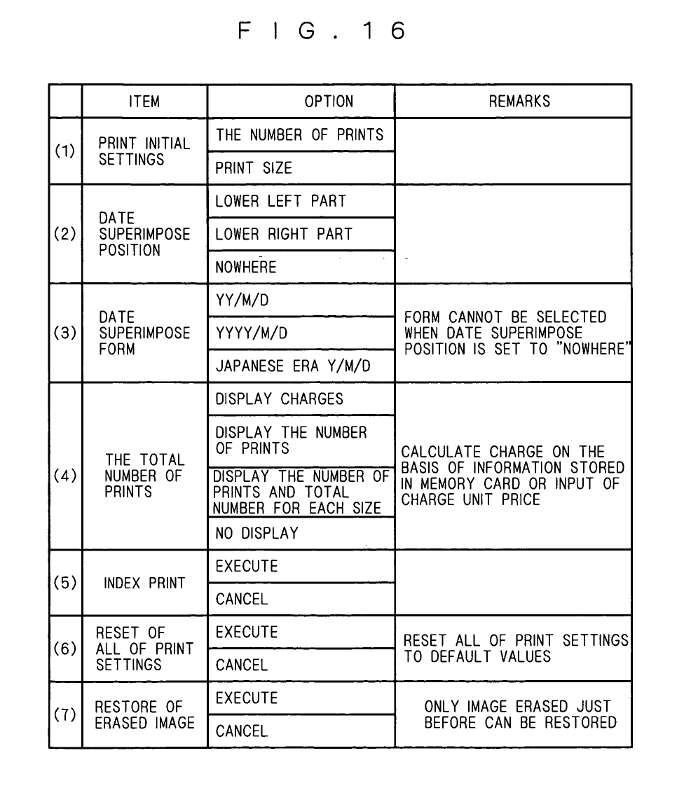

When the menu button 8a is depressed in the print setting screen, the program shifts to the print menu screen Gpm shown in FIG. 15. The print menu screen Gpm will now be described.

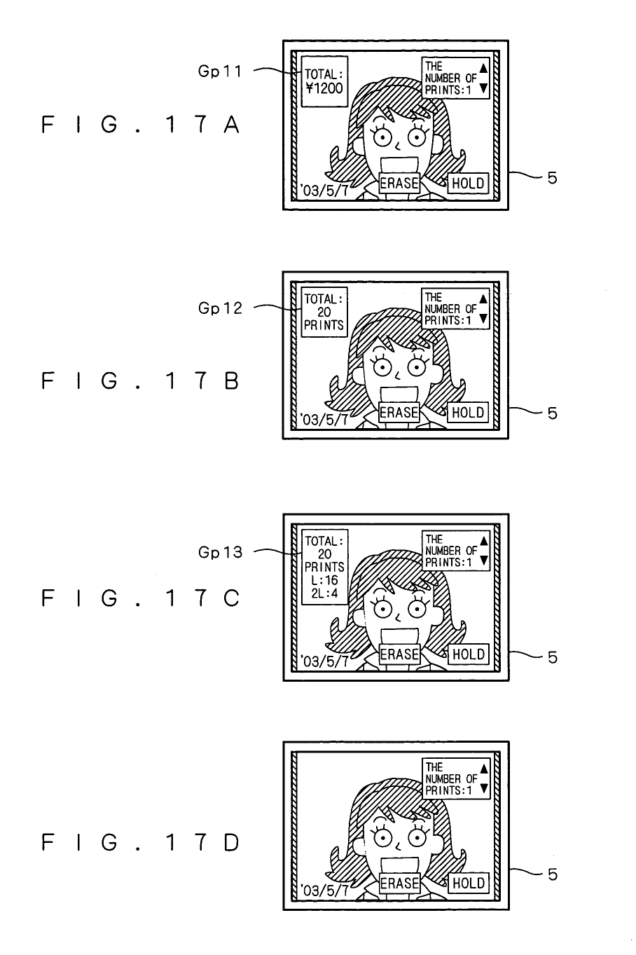

FIG. 16 is a diagram for describing the items displayed in the print menu screen Gpm. In the following, the functions of the print menu screen will be described for each of the items (1) to (7) shown in FIG. 16.

(1) When the print initial setting is designated, the default number of prints or default print size can be selected with respect to print designation by using the button group 7. In the digital camera 1, the default print setting conditions can be changed.

(2) When a date superimpose position is designated, with respect to the date superimpose position on a print image corresponding to the date display Gp5 (FIG. 7), “lower left” in an image (screen), “lower right” in an image, or “none” for inhibiting date superimpose can be selected.

(3) After the date superimpose form is designated, the form of “YY/M/D”, “YYYY/M/D” or “Japanese Era Y/M/D” can be selected. In the case where the date superimpose position is set to “none”, the date superimpose form cannot be designated.

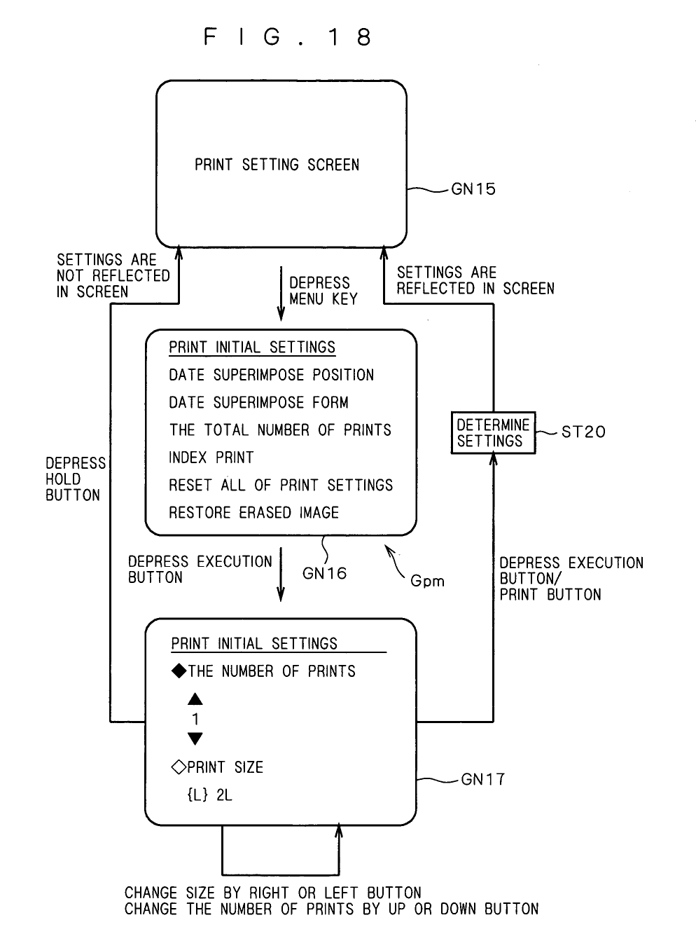

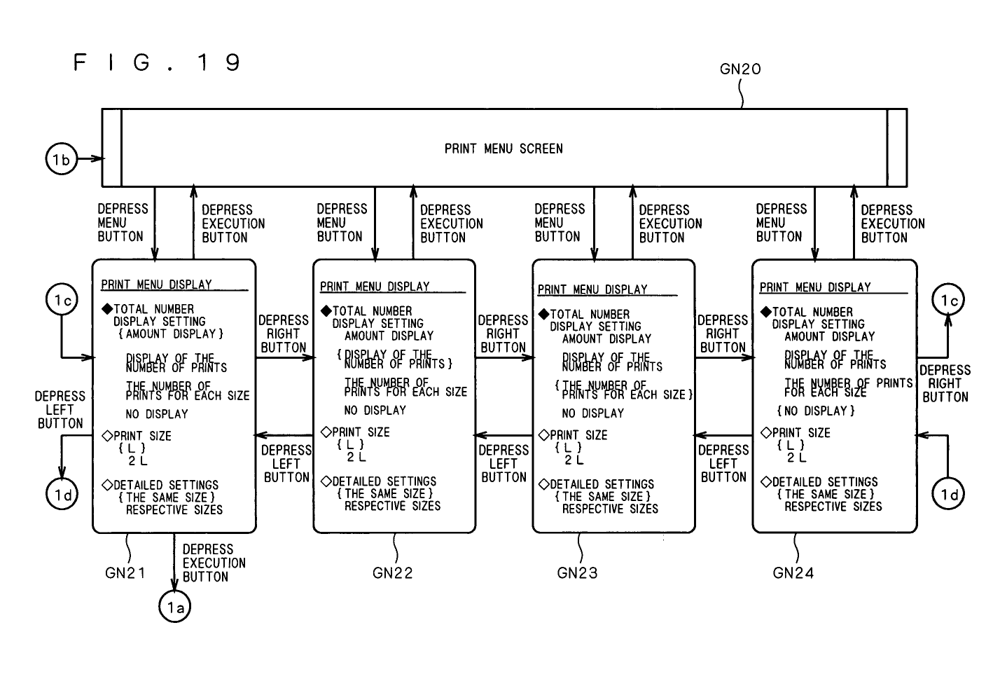

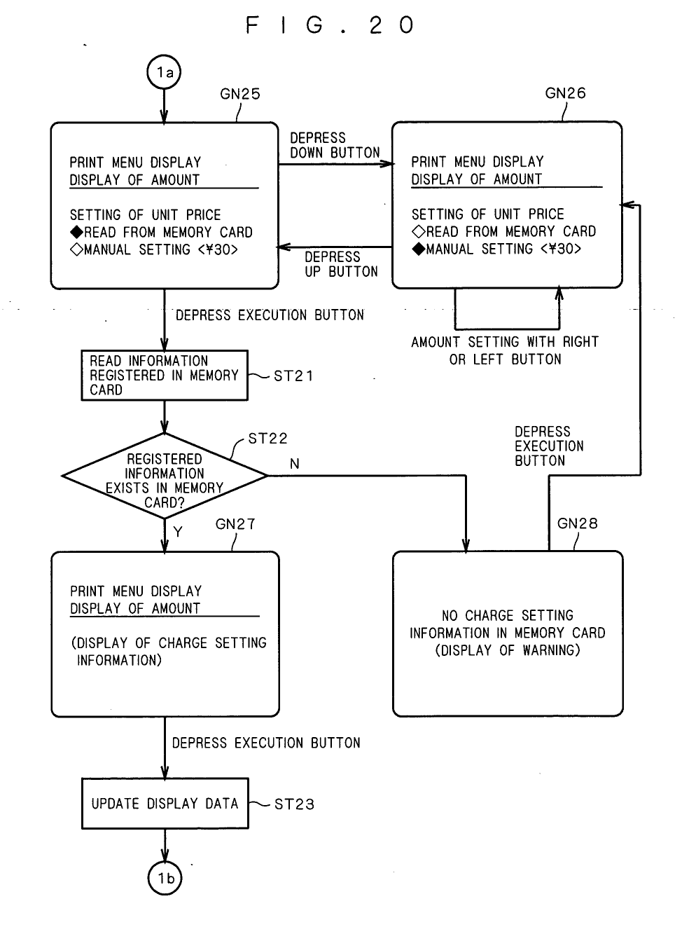

(4) When the total number of prints is designated, “display of charge”, “display of the number of prints”, “display of the number of prints for each size and the total number” or “no display” can be selected. When “display of charge” is set, the display Gp11 of the charge is made on the LCD 5 as shown in FIG. 17A. When “display of the number of prints” is set, display Gp12 of only the total number is made on the LCD 5 as shown in FIG. 17B. When “display of the number of prints for each size and the total number” is set, as shown in FIG. 17C, the display Gp13 of the total number, the number of prints of the L size, and the number of prints of the 2L size is made on the LCD 5. When “no display” is set, as shown in FIG. 17D, the total number is not displayed on the LCD 5. In the case of displaying charges, for example, the charge is calculated on the basis of the print unit price table TB in the memory card 90.

(5) When the index print is designated, either “yes” or “no” of index print can be selected.

(6) When reset of all of the print settings is designated, “execute” or “cancel” can be selected. In the case where “execute” is selected, the settings of all of the numbers of prints are reset to the default values which are set in the print initial settings.

(7) When restore of the erased image is designated, “execute” or “cancel” can be selected. Even in the case where “execute” is selected, to effectively utilize the capacity of the memory card, an image which can be restored is only the image erased just before.

As described above, settings can be made for each of the items shown in FIG. 16. As a concrete example, operations of making print initial settings and setting of the total number of prints will now be described.

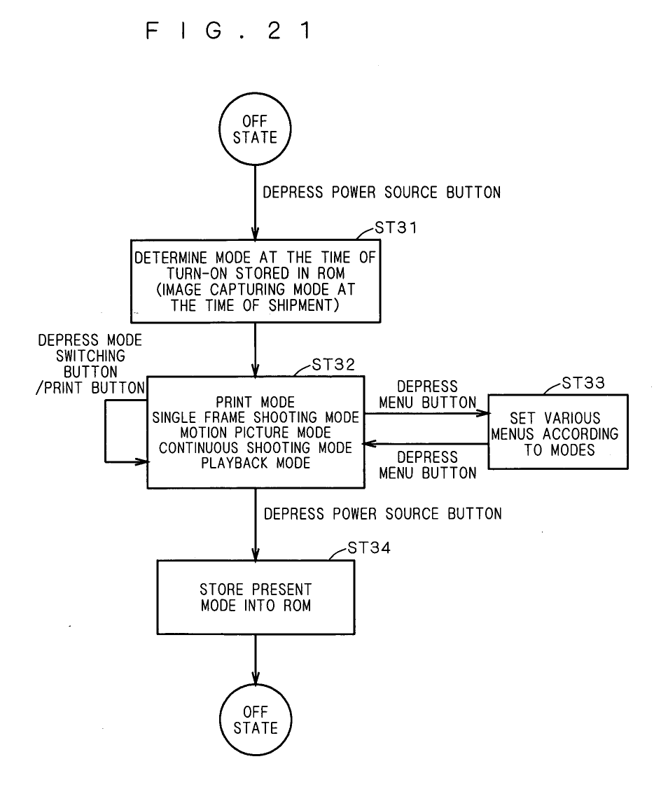

FIG. 18 is a diagram for describing the operation of the print initial settings. In the diagram, blocks having reference symbols starting with GN indicate states of the display screen, and blocks having reference symbols starting with ST show processes of the digital camera 1.

When the menu button 8a is depressed in a state GN15 displaying the print setting screen, the program shifts to a state GN16 in which the print menu screen Gpm is displayed. When the “print initial setting” is selected in the state GN16 and the execution (center) button 7e is depressed, the program shifts to a state GN 17 in which the screen for making the print initial setting is displayed.

In the display state GN17, an initial setting of the number of prints and an initial setting of the print size can be made. For example, when the number of prints is set as two, in the print setting screen in which an image is displayed first, “2” is displayed in the order number display Gp2. In such a manner, initial settings can be easily made, so that convenience of the user improves.

In the display state GN17, the number of prints can be changed by depressing the up button 7a or down button 7b, and the print size can be changed by depressing the right button 7d or left button 7c.

When the execution (center) button 7e or print button 13 is depressed in the display state GN17, the program shifts to the state GN15 showing the print setting screen in which the initial settings are reflected. Specifically, in the case where the print button 13 is operated when the print menu screen (menu setting screen) is displayed, the print menu screen is immediately switched to the print setting screen. In the print setting screen, display in which the result of settings made on the print menu screen is reflected is performed (for example, when the number of prints is changed to two, two images are displayed).

On the other hand, when the hold button 7c is depressed in the display state GN17, the program shifts to the state GN15 displaying the print setting screen in which the result of settings in the state GN17 is not reflected.

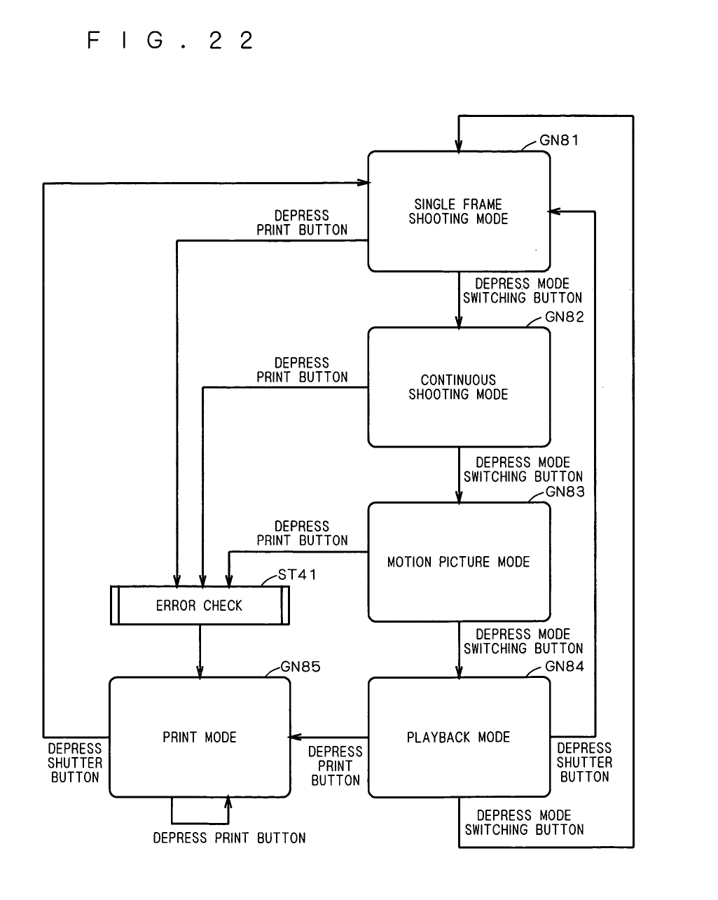

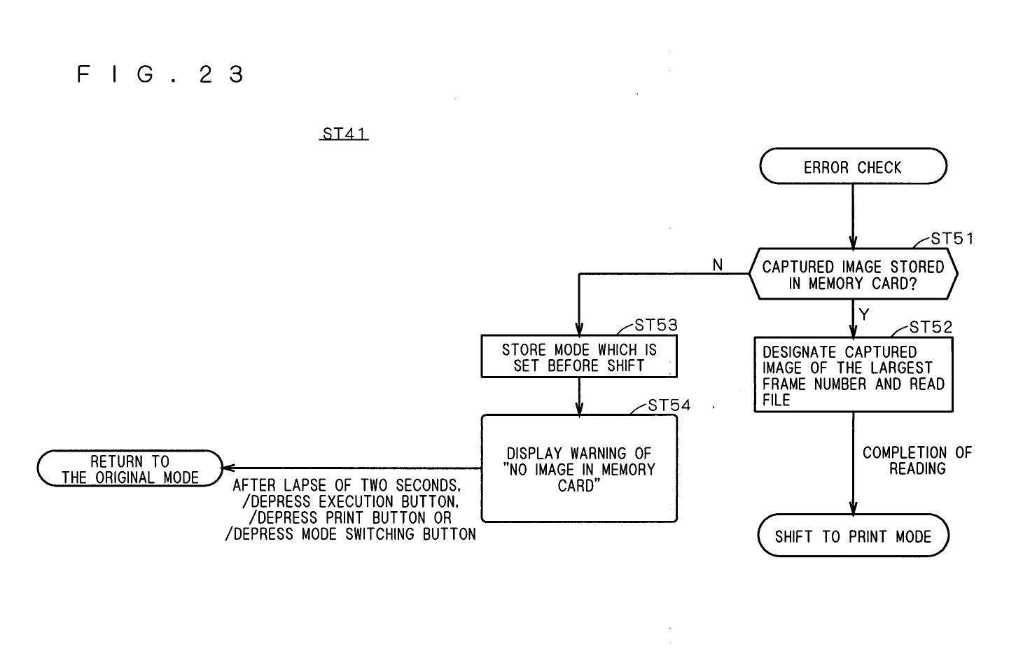

FIGS. 19 and 20 are diagrams for describing a print total number display setting operation. In the diagrams, blocks having reference symbols starting with GN indicate states of the display screen, and blocks having reference symbols starting with ST show processes of the digital camera 1.

In the case where the menu button 8a is depressed in a state GN20 in which the print menu screen Gpm (FIG. 15) is displayed, the program shifts to any of menu display states GN21 to GN24 corresponding to print setting screens (four kinds of screens shown in FIGS. 17A to 17D) immediately before a shift to the print menu screen Gpm. In the menu display states GN21 to GN24, the setting of the total number of prints can be changed. The setting can be changed by depressing the right and left buttons 7d and 7c.

When the execution (center) button 7e is depressed in the state GN21 in which an amount display setting is selected, the program shifts to the state GN25 in which a screen for selecting “reading from memory card” for a unit price setting is displayed. When the execution (center) button 7e is depressed, a process ST21 of reading registered information of the memory card 90, that is, the print unit price table TB shown in FIG. 4 is performed, and a process ST22 of determining whether registered information exists in the memory card 90 or not is performed. In the case where registered information exists in the process ST22, the program shifts to a state GN27 in which charge setting data is displayed on the basis of the information and, by depression of the execution (center) button 7e, a process ST23 of updating the displayed data is executed. On the other hand, when registered information does not exist in the process ST22, the program shifts to a state GN28 in which a warning of “no charge information in the memory card” is displayed. When the execution (center) button 7e is depressed in this state GN28, the program shifts to a state GN26.

On the other hand, when the down button 7b is depressed in a state GN25, the program shifts to the state GN26 in which a screen for selecting “manual setting” for unit price setting is displayed. In this case, the amount can be increased/decreased by operating the left and right buttons 7c and 7d. When the up button 7a is depressed, the program shifts to the state GN25.

General Operation of Digital Camera 1

The operation regarding the print mode has been described above. The general operation of the digital camera 1 such as the relation between the print mode and the other modes (image capturing mode and playback mode) will be described below.

FIG. 21 is a state transition diagram showing basic operation of the digital camera 1.

First, when the power source button 3 is depressed in a state where the power source of the digital camera 1 is off, the program shifts to a state ST31 of checking a mode at the time of turn-on stored in the ROM 50b. At the time of shipment of the digital camera 1, the image capturing mode is set.

The program shifts to a state ST32 in which the mode determined in state ST31 is set. As the modes of the digital camera 1, there are the print mode, image capturing modes (single frame shooting mode, motion picture mode and continuous shooting mode) and playback mode. By depression of the mode switching button 11 and the print button 13, the mode can be switched among the five kinds of modes. In the case where the menu button 8a is depressed in the state ST32, the program shifts to a state ST33 in which a screen for setting various menus according to the mode is displayed on the LCD 5.

On the other hand, when the power source button 3 is depressed in the state ST32, via a state ST34 for storing the currently set mode into the ROM 50b, the power source of the digital camera 1 is turned off.

The relation between the print mode as one of the five modes and the other four kinds of modes will be described with reference to FIG. 22 showing a state transition.

In states GN81 to GN84 in which the single frame shooting mode, continuous shooting mode, motion picture mode and playback mode are set, respectively, the mode is cyclically switched by depression of the mode switching button 11. At the time of shifting the state GN83 in which the motion picture mode is set to the state GN84 in which the playback mode is set, a captured image of the largest frame number is displayed on the LCD 5.

When the print button 13 is depressed in the states GN81 to GN83 in which the single frame shooting mode, continuous shooting mode and motion picture mode are set, respectively, via an error check ST41 which will be described in detail later, the program shifts to a state GN85 in which the print mode is set. That is, when the print button (predetermined operation member) 13 is operated, the screen is immediately switched to the print setting screen. Immediately after the shift to the state GN85, a captured image of the largest frame number is displayed on the LCD 5.

When the print button 13 is depressed in the state GN84 in which the playback mode is set, the program shifts to the state GN85 in which the print mode is set. Immediately after the shift to the state GN85, the same image as an image played back on the LCD 5 in the state GN84 is displayed. When the shutter button 9 is depressed in the state GN84, the program shifts to the state GN81 in which the single frame shooting mode is set.

Also when the print button 13 is depressed in the state GN85 in which the print mode is set, a process of updating the print order contents or the like is performed as described above, but the setting of the print mode is maintained. In the case where the shutter button 9 is depressed in the state GN85, the program shifts to the state GN81 in which the single frame shooting mode is set.

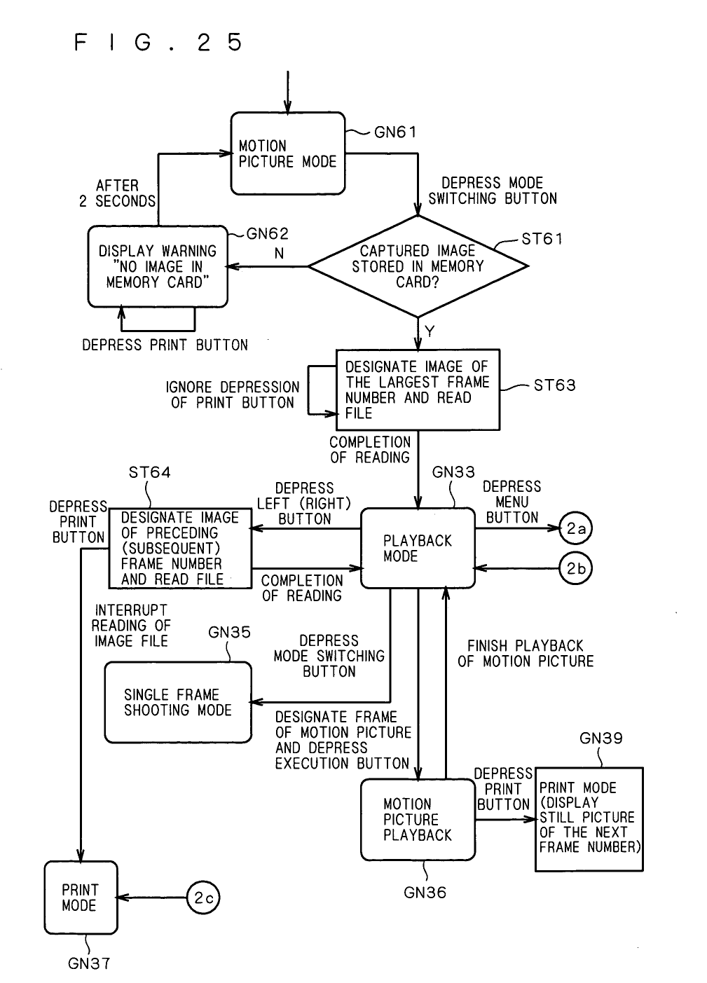

FIG. 23 is a flowchart showing the operation of an error check corresponding to the state ST41.

First, it is determined whether a captured image is stored in the memory card 90 or not (step ST51). In the case where a captured image is stored, the program advances to step ST52. In the case where a captured image is not stored, the program advances to step ST53.

In step ST52, a captured image of the largest frame number is designated and an image file (data) is read. After completion of the reading, the program shifts to the state GN85 (FIG. 22) in which the print mode is set. Even when the print button 13 is depressed in step ST52, the print button 13 is ignored and the reading of a file is continued.

In step ST53, the mode (single frame shooting mode, continuous shooting mode or motion picture mode) which is set before the shift to the error check ST45 is stored.

In step ST54, a warning that “there is no image in memory card” is displayed on the LCD 5. After lapse of two seconds, in response to the depression of the execution (center) button 7e, print button 13 or mode switching button 11, the program returns to the mode before the shift stored in the step ST53.

As described above, in the case where the print button 13 is operated in a state where an image to be printed is not recorded on the memory card 90, by the error check operation of inhibiting the switch to the print setting screen and displaying a warning on the LCD 5, the digital camera 1 can be prevented from shifting to the print mode when there is no captured image in the memory card 90.

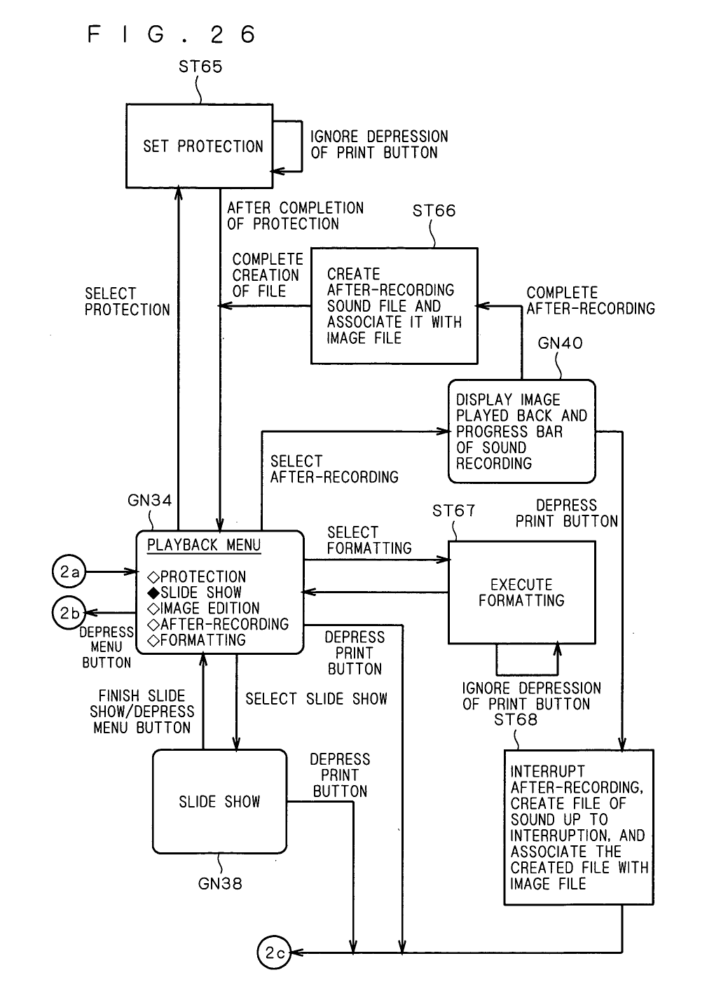

The process performed in the case where the print button 13 is depressed in each of the states of the digital camera 1 in the playback mode will be described with respect to each of the items (1) to (6) shown in FIG. 24.

(1) When the print button 13 is depressed in the state where the menu screen of the playback mode (hereinafter, also referred to as a “playback menu”) is being displayed, the program immediately shifts to the print setting screen Gp (FIG. 7).

(2) When the print button 13 is depressed during a slide show, the slide show is interrupted and the program shifts to the print setting screen Gp.

(3) When the print button 13 is depressed during playback of a motion picture (continuous playback of a motion picture file), the motion picture playback is interrupted, and the program shifts to the print setting screen Gp displaying the subsequent still picture of the motion picture presently being played back for the reason that printing cannot be designated for a motion picture. If the subsequent still picture does not exist after the motion picture being played back, the still picture before the motion picture is displayed.

(4) When the print button 13 is depressed during a file access (reading) by frame advance, enlarge display, image process or the like, the program interrupts the file access and shifts to the print setting screen Gp. In the case where the mode shift is being performed, priority is given to reading of data.

(5) Even when the print button 13 is depressed during a file access (writing) by the image process, a setting of copy, erase, or protect, updating of a print order file, or the like, it is ignored in order to prevent the file from being destroyed.

(6) When the print button 13 is depressed during after-recording, the program interrupts the after-recording and, after completion of recording of sound up to the interruption, shifts to the print setting screen Gp of a frame to be after-recorded. In the print setting screen Gp, sound information regarding the after-recording is not displayed but a still picture which is not related to the after-recording is displayed.

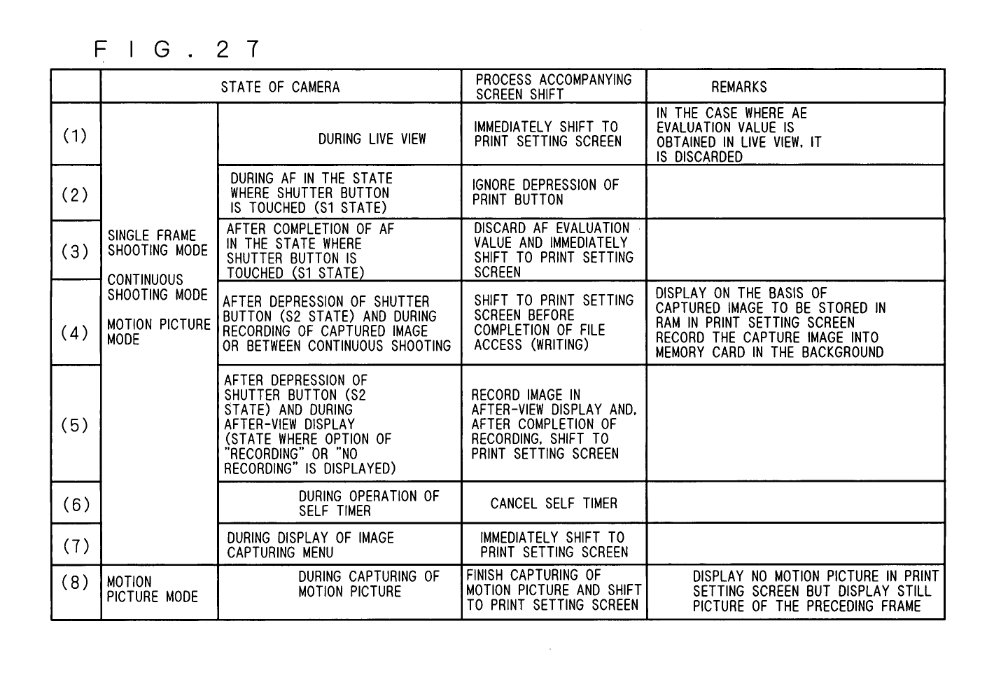

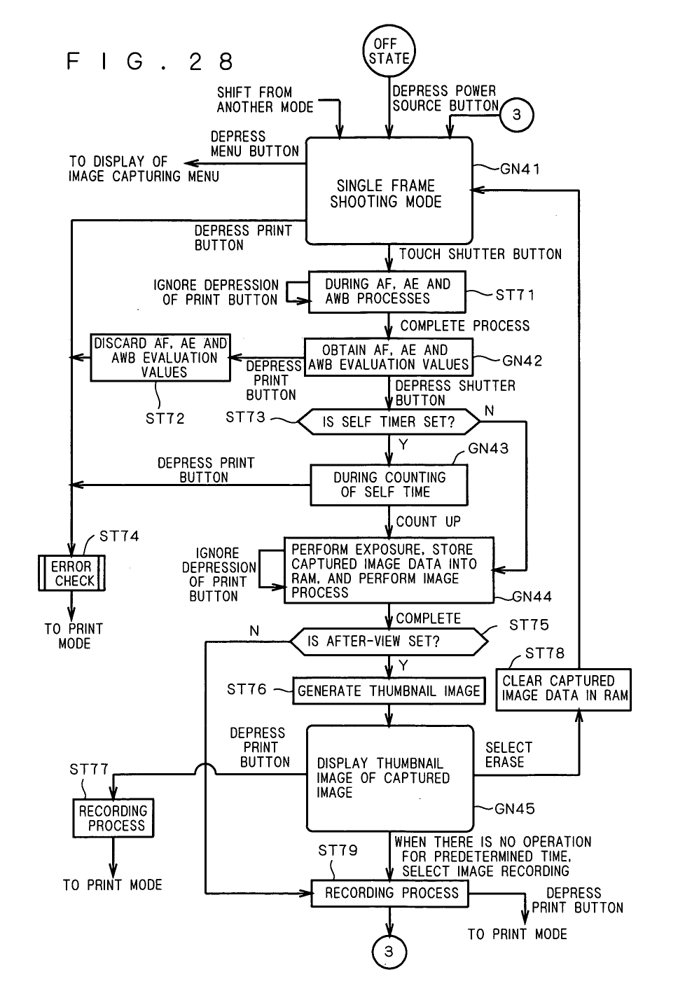

FIGS. 25 and 26 are diagrams for describing operations of the digital camera 1 in the playback mode. In the diagrams, blocks having reference symbols starting with GN indicate states of the digital camera, and blocks having reference symbols starting with ST indicate processes of the digital camera 1.

When the mode switching button 11 is depressed in a state GN61 in which the motion picture mode is set as shown in FIG. 25, a process ST61 of determining whether a captured image is stored in the memory card 90 or not is performed. If it is found in the process ST61 that the captured image is stored, a process ST63 of designating an image of the largest frame number and reading the image file is performed. After completion of the reading, the program shifts to a state GN33 in which the playback mode of displaying the image of the frame number is displayed. Even in the case where the print button 13 is depressed while the process ST63 is performed, it is ignored and the reading process is continued.

On the other hand, if it is found in the process ST61 that a captured image is not stored, the program shifts to a state GN62 in which a warning of “there is no image in memory card” is displayed. After two seconds, the program shifts to the state GN61 in which the motion picture mode is set. Even when the print button 13 is depressed in the state GN62, it is ignored.

When the left button 7c (or right button 7d) is depressed in the state GN33 in which the playback mode is set, a process ST64 of designating an image of the preceding (or subsequent) frame number and reading an image file is performed. After completion of the process ST64, the program shifts to the state GN33 in which the playback mode displaying the read image file is set. In the process ST64, when the print button 13 is depressed, reading of an image file is interrupted, and the program shifts to a state GN37 in which the print mode of displaying the image displayed immediately before the reading process is set.

In the case where the mode switching button 11 is depressed in the state GN33 in which the playback mode is set, the program shifts to a state GN35 in which the single frame shooting mode is set. When the frame of a motion picture is designated and the execution (center) button 7e is depressed in the case where an image is displayed in the form of a thumbnail image in the state GN33, the program shifts to a state GN36 of playing back the motion picture of the designated frames. When the print button 13 is depressed in this state GN36, the program shifts to a state GN39 in which the print mode of displaying a still picture of the subsequent frame number is set.

When the menu button 8a is depressed in the state GN33 in which the playback mode is set, the program shifts to a state GN34 in which the menu screen of the playback mode shown in FIG. 26 is displayed. When the menu button 8a is depressed, the program returns to the state GN33 in which the playback mode shown in FIG. 25 is set.

In the case where “protect” as a menu item is selected and the execution (center) button 7e is depressed in the state GN34 in which the playback menu is displayed as shown in FIG. 26, a process ST65 of setting protection is performed. After completion of the setting of protection, the program returns to the state GN34 in which the playback menu is displayed. Even in the case where the print button 13 is depressed during the protection setting process ST65, it is ignored and the protection setting is continued.

In the case where “after-recording” as a menu item is selected and the execution (center) button 7e is executed in the state GN34 in which the playback menu is displayed, the program shifts to a state GN40 displaying an image played back and a progress bar of sound recording. In the state GN40, when the after-recording is finished, a process ST66 of creating an after-recording sound file in the memory card 90 and associating the created after-recording sound file with an image file is performed. After completion of creation of the after-recording sound file, the program shifts to the state GN34 displaying the playback menu. On the other hand, in the case where the print button 13 is depressed in the state GN40, after-recording is interrupted, a process ST68 of creating a sound file up to the interruption and associating the sound file with an image file of an image played back is performed. The program shifts to the state GN37 (FIG. 25) in which the print mode of displaying the image played back is set. That is, when the print button 13 is operated during sound recording, the sound recording is interrupted, and the display screen is immediately switched to the print setting screen.

In the case where “formatting” as a menu item is selected and the execution (center) button 7e is depressed in the state GN34 in which the playback menu shown in FIG. 26 is displayed, a process ST67 of executing formatting is executed. When the formatting is completed, the program returns to the state GN34 in which the playback menu is displayed. Even in the case where the print button 13 is depressed during the formatting process ST67, it is ignored and the formatting process is continued.

In the case where “slide show” as a menu item is selected and the execution button 7e is depressed in the state GN34 in which the playback menu is displayed, the program shifts to a state GN38 where the slide show is executed. In the case where the slide show is finished and the menu button 8a is depressed in the state GN38, the program returns to the state GN34 in which the playback menu is displayed. When the print button 13 is depressed in the state GN38, the program shifts to the state GN37 (FIG. 25) in which the print mode of displaying the print setting screen is set.

When the print button 13 is depressed in the state GN34 in which the playback menu shown in FIG. 26 is displayed, the program shifts to the state GN37 (FIG. 25) in which the print mode of displaying the print setting screen is set.

Although the relation between the playback mode and the print mode has been described above, in the following, the process performed when the print button 13 is depressed in each of the states of the digital camera 1 in the image capturing modes other than the playback mode, concretely, the single frame shooting mode, continuous shooting mode and motion picture mode will be described with respect to each of the items (1) to (8) shown in FIG. 27.

(1) When the print button 13 is depressed during live view display, the program immediately shifts to the print setting screen Gp (FIG. 7). In the case where an AE evaluation value is obtained in a live view, it is discarded.

(2) Even when the shutter button 9 is half-pressed (S1 state) and the print button 13 is depressed during AF, the depression is ignored. That is, in the case where the shutter button 9 is depressed and the print button 13 is operated during live view display in which the taking lens 2 is driven, the program inhibits switch to the print setting screen.

(3) When the print button 13 is depressed after the shutter button 9 is half-pressed (S1 state) and AF is completed, the program discards an AF evaluation value obtained and immediately shifts to the print setting screen Gp. Specifically, when the print button 13 is operated in a state where a live view is being displayed (during image capturing operation), an AF evaluation value (control data regarding image capturing) calculated by the overall controller 50 and held in the RAM 50a is erased, and the display screen is switched to the print setting screen.

(4) After the shutter button 9 is depressed (S2 state) and during recording of a captured image or between image captures in the continuous shooting, by depression of the print button 13, the program shifts to the print setting screen Gp before a file access (writing) is completed. In the print setting screen, a thumbnail image (image for display) generated on the basis of a captured image to be stored in the RAM 50a is displayed. While maintaining display of the print setting screen switched, the captured image is concurrently recorded into the memory card 90 in the background. In the case where the erase button 8b is depressed in the print setting screen and an image erasing operation is performed, the captured image recording process is interrupted, and the captured image data stored in the RAM 50a is erased.

(5) During an after view display of displaying a captured image on the LCD 5 after the shutter button 9 is depressed (S2 state) (in the state where an option of “to record” or “not to record” is displayed), an image displayed as an after view is recorded by depressing the print button 13. After completion of the recording, the program shifts to the print setting screen Gp.

(6) When the print button 13 is depressed during a self timer operation, the program cancels the self timer and shifts to the print mode. Specifically, when the print button 13 is operated during operation of the self timer in the image capturing mode (during the image capturing operation), the operation of the self timer is stopped, and the program shifts to the print setting screen immediately.

(7) When the print button 13 is depressed during display of the menu screen of the image capturing mode (hereinafter, also referred to as “image capturing menu”), the program immediately shifts to the print setting screen Gp.

(8) When the print button 13 is depressed during capturing of a motion picture in the motion picture mode, the program finishes the motion picture capturing and shifts to the print setting screen Gp. That is, when the print button 13 is operated, capturing of a motion picture and recording of the captured motion picture is stopped, and the program immediately shifts to the print setting screen. In the print setting screen, a captured motion picture is not displayed but a still image which is different from the motion picture and has been captured before the motion picture capturing is displayed.

The operation of the digital camera 1 in each of the single frame shooting mode, continuous shooting mode and motion picture mode will be described below.

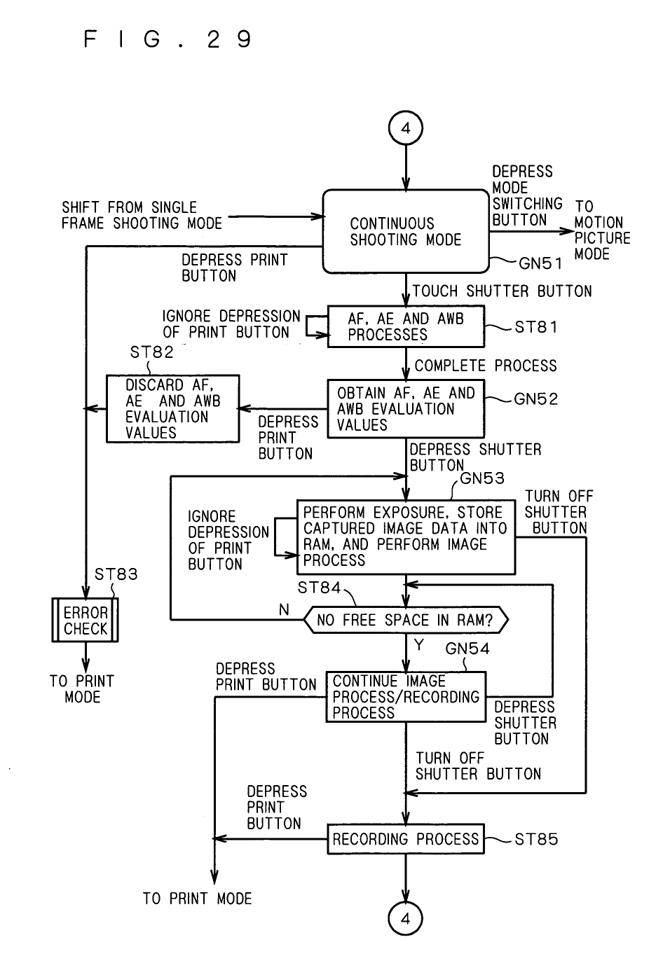

FIG. 28 is a diagram for describing the operation of the digital camera 1 in the single frame shooting mode. In the diagram, blocks having reference symbols starting with GN indicate the states of the digital camera, and blocks having reference symbols starting with ST show processes of the digital camera 1.

When the single frame shooting mode is set and the shutter button 9 is half-pressed in a state GN41 in which live view display is made, AF, AE and AWB processes ST71 are performed. After completion of the process, the program shifts to a state GN42 in which AF, AE and AWB evaluation values are obtained. When the print button 13 is depressed during the AF, AE and AWB processes ST71, the depression is ignored, and shift to the print mode is inhibited.

When the menu button 8a is depressed in the state GN41 in which the single frame shooting mode is set, the program shifts to a state where the image capturing menu which will be described later is displayed.

When the print button 13 is depressed in the state GN42 where the AF, AE and AWB evaluation values are obtained, a process ST72 of discarding the AF, AE and AWB evaluation values is performed and, after that, the error check process ST74 is performed. On the other hand, when the shutter button 9 is depressed in the state GN42, a process ST73 of determining whether the self timer is set or not is performed. In the case where the self timer is set, the program shifts to a self timer counting state GN43. On the other hand, in the case where the self timer is not set, the program shifts to a state GN44 of performing exposure, storing captured image data into the RAM 50a, and performing an image process.

When the print button 13 is depressed in the state GN43 of counting the self timer, the program cancels the self timer and shifts to the error check process ST74. On the other hand, when the self timer is counted up in the state GN43, the program shifts to the state GN44 of performing exposure and the like.

Even when the print button 13 is depressed in the state GN44 of performing exposure and the like, it is ignored and the exposing process or the like is continued. After completion of the image process in the state GN44, the program shifts to a process ST75 of determining whether after-view is set or not.

In the case where after-view is set in the determining process ST75, a process ST76 of generating a thumbnail image for display of the thumbnail image data SD (FIG. 4) is performed, and the program shifts to a state GN45 of displaying the thumbnail image of a captured image. On the other hand, when the after-view is not set in the determining process ST75, a process ST79 of recording the captured image into the memory card 90 is performed and, after that, the program shifts to the state GN41 in which the single frame shooting mode is set, and the live view display is made. When the print button 13 is depressed during the recording process ST79, even writing has not been completed, the program immediately shifts to the print mode of the print setting screen accompanying display of a thumbnail image (image for display).

In the case where the print button 13 is depressed in the thumbnail image display state GN45, a process ST77 of recording a captured image into the memory card 90 is performed, and the program shifts to the print mode.

In the case where there is no user's operation for predetermined time (for example, three seconds) or image recording is selected by the user in the thumbnail image display state GN45, the program shifts to the recording process ST79.

In the case where erase of an image is selected in the thumbnail image display state GN45, the captured image data in the RAM 50a is cleared, and the program shifts to the single frame shooting mode setting screen GN41 and performs live view display.

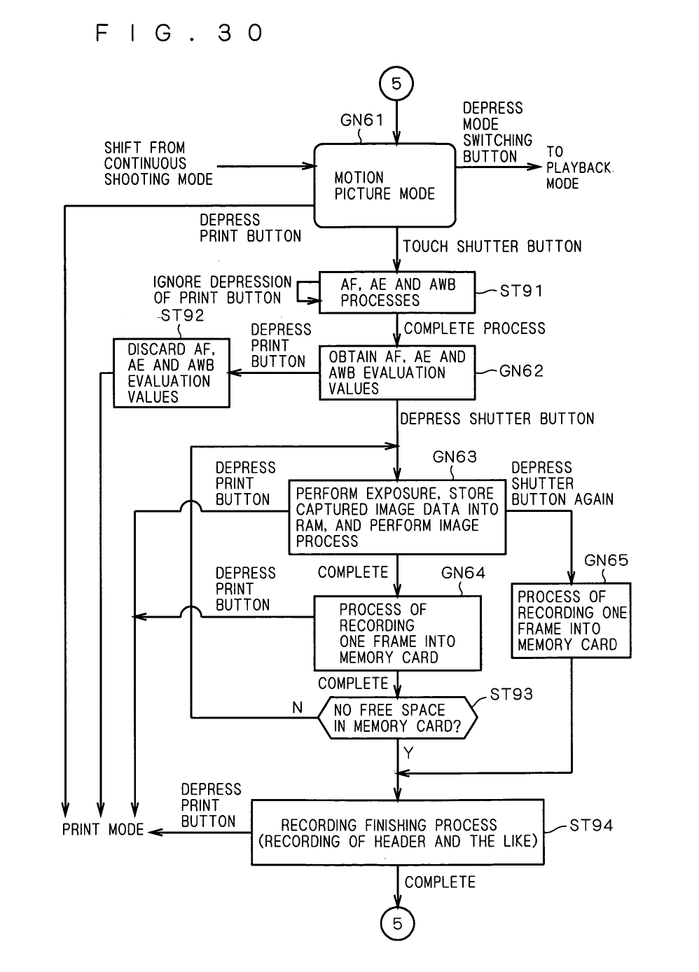

FIG. 29 is a diagram for describing the operation of the digital camera 1 in the continuous shooting mode. In the diagram, blocks having reference symbols starting with GN indicate states of the digital camera, and blocks having reference symbols starting with ST show processes of the digital camera 1.

When the shutter button 9 is half-pressed in a state GN51 where the continuous shooting mode is set and the live view display is performed, an AF, AE and AWB process ST81 is performed. After completion of the process, the program shifts to a state GN52 where the AF, AE and AWB evaluation values are obtained. Even if the print button 13 is depressed in the AF, AE and AWB process ST81, the depression is ignored and shift to the print mode is inhibited.

When the print button 13 is depressed in the state GN52 in which the AF, AE and AWB evaluation values are obtained, a process ST82 of discarding the AF, AE and AWB evaluation values is performed and, after that, the error check process ST83 is performed. On the other hand, when the shutter button 9 is depressed in the state GN52, the program shifts to a state GN53 of performing exposure, storing captured image data into the RAM 50a, and performing the image process.

In the state GN53 of performing the exposure and the like, even if the print button 13 is depressed, it is ignored and the process such as exposure is continued. After the image process is completed in the state GN53, the program shifts to a process ST84 of determining whether there is a free space in the RAM 50a or not. In the case where the shutter button 9 is turned off in the state GN53, a recording process ST85 is performed on the memory card 90. After that, the program shifts to the state GN51 and the live view display is performed.

In the case where there is no free space in the RAM 50a in the determining process ST84, the program shifts to a state GN54 of continuing the image process and the recording process. On the other hand, in the case where there is a free space in the RAM 50a, the program shifts to the state ST53 where exposure and the like are performed.

In the case where the shutter button 9 is depressed in the state GN54, the program shifts to the determining process ST84 for checking a free space. On the other hand, in the case where the shutter button 9 is turned off, the program shifts to the process ST85 of recording a captured image onto the memory card 90.

In the case where the print button 13 is depressed during the state GN54 or the recording process ST85, the program shifts to the print mode.

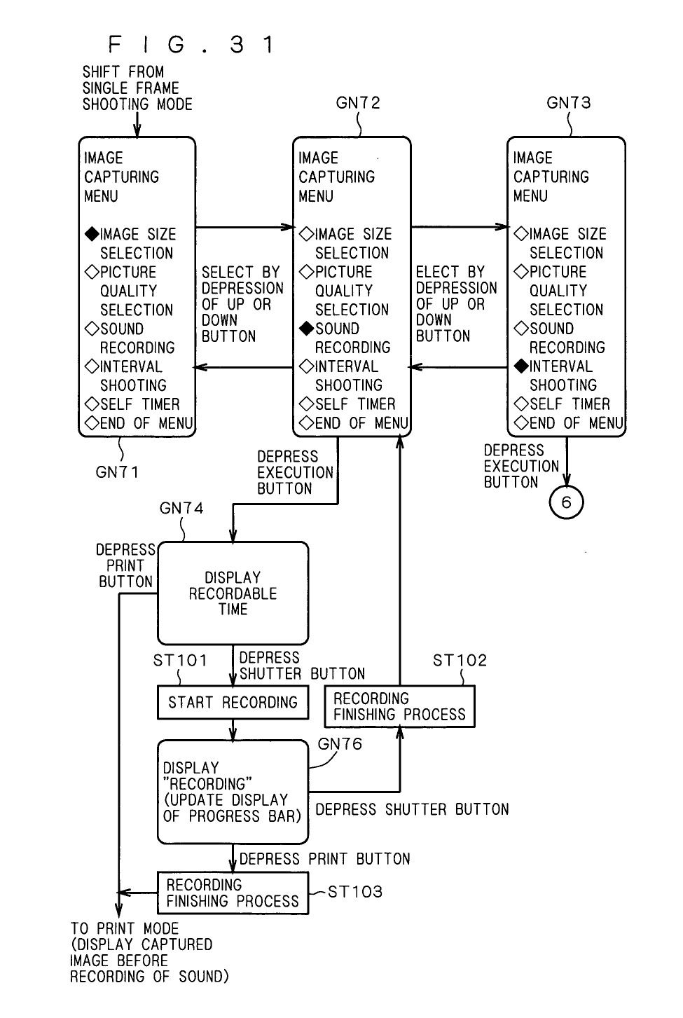

FIG. 30 is a diagram for describing the operation of the digital camera 1 in the motion picture mode. In the diagram, blocks having reference symbols starting with GN indicate states of the digital camera, and blocks having reference symbols starting with ST indicate processes of the digital camera 1.

In the case where the shutter button 9 is half-pressed in a state GN61 where the motion picture mode is set and live view display is performed, an AF, AE and AWB process ST91 is performed. After completion of the processes, the program shifts to a state GN62 in which the AF, AE and AWB evaluation values are obtained. Even if the print button 13 is depressed in the AF, AE, and AWB process ST91, the depression is ignored, and shift to the print mode is inhibited.

When the print button 13 is depressed in the state GN62 in which the AF, AE and AWB evaluation values are obtained, the program performs a process ST92 of discarding the AF, AE and AWB evaluation values and shifts to the print mode. On the other hand, when the shutter button 9 is depressed in the state GN62, the program shifts to a state GN63 of performing exposure, storing captured image data into the RAM 50a, and performing the image process. When the print button 13 is depressed in the state GN63, the program shifts to the print mode.

After completion of the image process in the state GN63, the program shifts to a state GN64 of performing a process of recording one frame to the memory card 90. After that, the program shifts to a state ST93 of determining whether there is a free space in the memory card 90 or not. In the case where the print button 13 is depressed in the state GN64, the program immediately shifts to the print mode.

By repeating the recording process for each of frames constructing a motion picture in the state GN64, motion picture data is generated.

In the case where the shutter button 9 is depressed again in the state GN63, the program shifts to a state GN65 of performing a recording process of one frame to the memory card 90 and, after that, a process ST94 of finishing recording of a motion picture file onto the memory card 90 is performed.

In the case where there is a free space in the memory card 90 in the determining process ST93, the program shifts to the state GN63. On the other hand, when there is no free space, the program shifts to the recording finishing process ST94.

In the recording finishing process ST94, a header and the like are added to image data of a motion picture captured, and the resultant is recorded as a motion picture file onto the memory card 90. After completion of the process ST94, the program shifts to the state GN61 in which the motion picture mode is set, and live view display is performed. When the print button 13 is depressed during the recording finishing process ST94, the program shifts to the print mode.

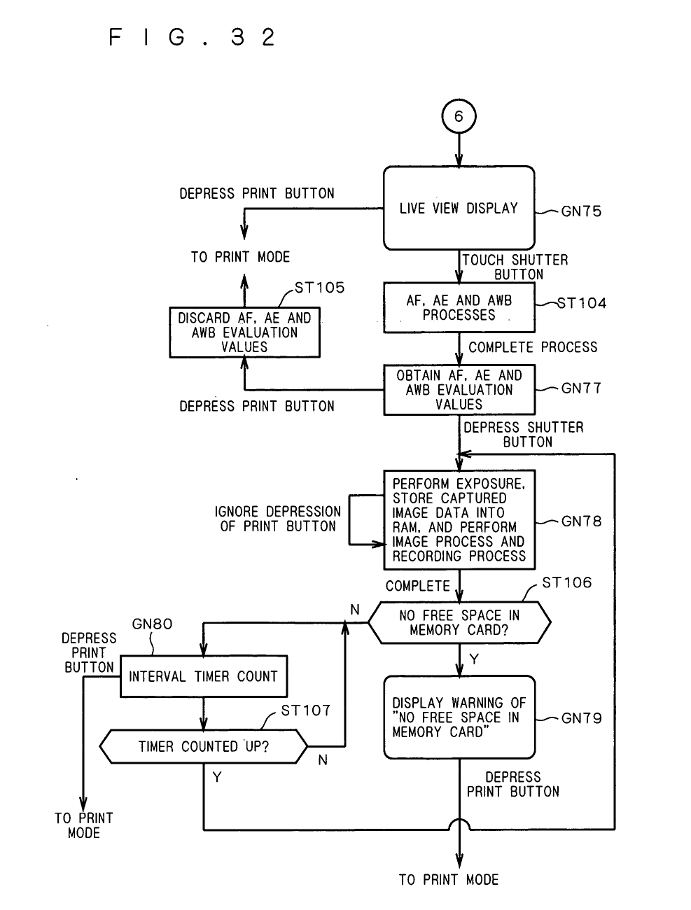

FIGS. 31 and 32 are diagrams for describing the operations of the digital camera 1 regarding the image capturing menu. In the diagrams, blocks having reference symbols starting with GN show states of the digital camera 1, and blocks having reference symbols starting with ST indicate processes of the digital camera 1.

When the menu button 8a is depressed in the single frame shooting mode, the program shifts to a state GN71 of displaying the image capturing menu. In the image capturing menu screen, by depressing the up button 7a or down button 7b, a selected item can be changed to a state GN72, GN73 or the like.

When the execution (center) button 7e is depressed in the state GN72 where “sound recording” is selected, the program shifts to a state GN74 in which sound recordable time is displayed.

When the print button 13 is depressed in the state GN74, the program shifts to the print mode in which an image captured before the sound recording is displayed.

When the shutter button 9 is depressed in the state GN74, the program performs a process ST101 of starting sound recording and shifts to a state GN76 of displaying “recording” and also displaying a progress bar. When the shutter button 9 is depressed in the state GN76, the program performs a sound recording finishing process ST102 and shifts to the state GN72. On the other hand, when the print button 13 is depressed in the stage GN76, the program performs a sound recording finishing process ST103 and shifts to the print mode.

When the execution (center) button 7e is depressed in the state GN73 in which “interval shooting” is selected, the program shifts to a state GN75 (FIG. 32) where live view display is performed. When the print button 13 is depressed in the state GN75, the program shifts to the print mode. In this case, the display screen is switched to the print setting screen accompanying display of a still picture captured in, for example, the single frame shooting mode before the interval shooting mode is set.

When the shutter button 9 is half-pressed in the live view display state GN75, the program performs an AF, AE and AWB processes ST104 and, after completion of the process, shifts to a state GN77 where the AF, AE and AWB evaluation values are obtained.

When the print button 13 is depressed in this state GN77, the program performs a process ST105 of discarding the AF, AE and AWB evaluation values and, after that, shifts to the print mode.

When the shutter button 9 is depressed in the state GN77, the program shifts to a state GN78 of performing exposure, storing captured image data into the RAM 50a, and performing the image process and the recording process. Even if the print button 13 is depressed in this state GN78, it is ignored and the process is continued. Consequently, even if the print button 13 is touched by mistake at the time of image capturing, the image capturing is not interrupted.

When the image process is completed in the state GN78, the program shifts to a process ST106 of determining whether there is a free space in the memory card 90 or not. When there is no free space in the memory card 90 in the determining process ST106, the program shifts to a state GN79 of displaying a warning “no free space in the memory card”. When the print button 13 is depressed in the state GN79, the program shifts to the print mode.

On the other hand, when it is determined in the determining process ST106 that there is a free space in the memory card 90, the program shifts to a counting state GN80 of an interval timer and, after that, shifts to a process ST107 of determining count-up of the timer. In the case where the print button 13 is depressed in the state GN80, the timer counter is reset, the program immediately shifts to the print mode, and the display screen is switched to the print setting screen. In the print setting screen, at least one still picture captured by the interval shooting mode is displayed. In such a manner, cancel of the interval shooting and print designation can be performed simultaneously.

In the case where the timer has not been counted up in the determining process ST107, the program shifts to the state GN80. On the other hand, when the timer counts up, the program returns to the state GN78.

By the operation of the digital camera 1, when the print button 13 is depressed in a state where the single frame shooting mode or the like is set, the display screen is switched to the print setting screen, so that setting of a print order can be made promptly.

While the invention has been shown and described in detail, the foregoing description is in all aspects illustrative and not restrictive. It is therefore understood that numerous modifications and variations can be devised without departing from the scope of the invention.

1. A digital camera having an image capturing part which captures an image of a subject formed by an optical member, comprising:
(a) a display part which displays an image captured by said image capturing part;
(b) a mode setting member which sets an image capturing mode for capturing an image of said subject by said image capturing part; and
(c) a display controller which displays a print setting screen regarding printing of an image on said display part when a predetermined operation member is operated during a predetermined image capturing operation or recording of an image in said image capturing mode set by said mode setting member.

2. The digital camera according to claim 1, wherein
when said predetermined operation member is operated during a live view display in said image capturing mode, said display controller displays said print setting screen on said display part.

3. The digital camera according to claim 2, further comprising:
(d) an image capture controller which generates control data regarding image capturing on the basis of an image captured by said image capturing part during said live view display, and stores said control data into a memory, wherein
when said predetermined operation member is operated during said live view display in said image capturing mode, said display controller erase said control data stored in said memory and displays said print setting screen on said display part.

4. The digital camera according to claim 2, wherein
when said predetermined operation member is operated while a taking lens included in said optical member is driven during said live view display in said image capturing mode, said display controller inhibits display of said print setting screen on said display part.

5. The digital camera according to claim 2, wherein
when said predetermined operation part is operated after a member for instructing image capturing is operated during said live view display, said display controller inhibits displaying of said print setting screen on said display part.

6. The digital camera according to claim 1, further comprising:
(e) an image generator which generates recording image data to be recorded on a recording medium and display image data to be displayed on said display part on the basis of said image captured in said image capturing mode; and
(f) a recording controller which records said display image data generated by said image generator in said image capturing mode onto said recording medium, wherein
when said predetermined operation member is operated while image data is being recorded in said image capturing mode, said display controller displays said print setting screen including said display image onto said display part.

7. The digital camera according to claim 6, wherein
when said predetermined operation member is operated while said image data is being recorded, said recording controller records an image in a state where said print setting screen is displayed.

8. The digital camera according to claim 7, wherein
when erasing is instructed in said print setting screen, said recording controller interrupts recording of said image data and erases said image data stored in said memory before recording to said recording medium.

9. The digital camera according to claim 1, wherein
when said predetermined operation member is operated while moving picture capturing is performed in said image capturing mode, said display controller interrupts said motion picture capturing and displays said print setting screen on said display part.

10. The digital camera according to claim 9, wherein
a still picture different from a captured motion picture is displayed on said print setting screen which is displayed on said display part after interruption of said motion picture capturing.

11. The digital camera according to claim 1, wherein
when said predetermined operation member is operated during interval image capturing which is set in said image capturing mode, said display controller interrupts said interval image capturing and displays said print setting screen on said display part.

12. The digital camera according to claim 11, wherein
at least one still picture captured in said interval image capturing is displayed on said print setting screen displayed on said display part after interruption of said interval image capturing.

13. The digital camera according to claim 11, wherein
when said predetermined operation member is operated in a period since said interval image capturing is set until said interval image capturing starts, said display controller displays said print setting screen including a still picture captured before said interval image capturing is set onto said display part.

14. The digital camera according to claim 1, wherein
when said predetermined operation member is operated while a self timer which is set in said image capturing mode works, said display controller interrupts work of said self timer and displays said print setting screen on said display part.

15. A digital camera having an image capturing part which captures an image of a subject formed by an optical member, comprising:
(a) a display part which displays an image captured by said image capturing part;
(b) a recording controller which records data of an image captured by said image capturing part onto a recording medium; and
(c) a display controller which displays a print setting screen regarding printing of a captured image onto said display part when a predetermined operation member is operated, wherein
when said predetermined operation member is operated in a state where no image data is recorded on said recording medium, said display controller inhibits displaying of said printing setting screen onto said display part.

16. The digital camera according to claim 15, wherein
when said predetermined operation member is operated in a state where said image data is not recorded on said recording medium, said display controller inhibits displaying of said print setting screen on said display part and displays a warning on said display part.

17. A digital camera having an image capturing part which captures an image of a subject formed by an optical member, comprising:
(a) a display part which displays an image captured by said image capturing part;
(b) an operation part having a plurality of operation members for inputting an instruction; and
(c) a display controller which displays a print setting screen regarding printing of said image onto said display part when a predetermined operation member included in said plurality of operation members is operated, wherein
when said predetermined operation member is operated during sound recording, said display controller interrupts said sound recording and displays said printing setting screen onto said display part.

18. The digital camera according to claim 17, wherein
when said predetermined operation member is operated while sound is recorded in a state where a playback mode for playing back an image of said subject onto said display part is set by a mode setting member included in said operation part, said display controller displays said print setting screen including an image played back onto said display part.

19. The digital camera according to claim 17, wherein
when said predetermined operation member is operated while sound is recorded in a state where an image capturing mode for capturing an image of said subject is set by a mode setting member included in said operation part, said display controller displays said print setting screen including an image captured before operating said predetermined operation member onto said display part.

20. A digital camera having an image capturing part which captures an image of a subject formed by an optical member, comprising:
(a) a display part which displays an image captured by said image capturing part and a menu setting screen; and
(b) a display controller which displays a print setting screen regarding printing of said image onto said display part when a predetermined operation member is operated, wherein
when said predetermined operation member is operated while said menu setting screen is displayed on said display part, said display controller switches displaying on said display part from said menu setting screen to said print setting screen.

21. The digital camera according to claim 20, wherein
when said menu setting screen is a print menu setting screen regarding printing of said image, said display controller displays information which is set in said print menu setting screen in said print setting screen switched from said print menu setting screen.

22. A digital camera having an image capturing part which captures an image of a subject formed by an optical member, comprising:
(a) a display part which displays an image captured by said image capturing part and a menu setting screen; and
(b) a display controller which displays a print setting screen regarding printing of said image onto said display part when a predetermined operation member is operated, wherein
when said predetermined operation member is operated while a motion picture is continuously played back, said display controller interrupts continuous playback of said motion picture and displays onto said display part said print setting screen including a still picture other than said motion picture of which continuous playback was interrupted.
